(19) United States
(12) Patent Application Publication
(10) Pub. No.: US 2014/0133498 A1
(43) Pub. Date: May 15, 2014

(54) COMMUNICATION DEVICE AND COMMUNICATION METHOD

(71) Applicant: PANASONIC CORPORATION, Osaka (JP)

(72) Inventors: Tetsuro Sato, Kanagawa (JP); Tomohiro Imai, Kanagawa (JP); Mitsuki Yamada, Osaka (JP)

(73) Assignee: PANASONIC CORPORATION, Osaka (JP)

(21) Appl. No.: 14/131,459

(22) PCT Filed: Nov. 27, 2012
(86) PCT No.: PCT/JP2012/007605

§ 371 Date: Jan. 8, 2014

(30) Foreign Application Priority Data
Jan. 31, 2012 (JP) 2012-019160

(51) Int. Cl. H04L 29/06

(52) U.S. Cl. CPC H04L 65/607
USPC 370/474

(57) ABSTRACT

A data transmission device as the present communication device includes an RTP data packet creation unit which generates data packets, a data packet rearrangement processing unit which rearranges the data packets, and an FEC data creation unit which generates redundant packets for the data packets on the basis of rearranged data packets and matrix data applied to the data packets.

### TECHNICAL FIELD

The present disclosure relates to a communication device and a communication method. Particularly, the present disclosure relates to a technique for reducing a data amount of redundant packets added for correcting data errors.

### BACKGROUND ART

In the related art, a technique of recovering data is used when a packet loss occurs on a transmission path in data transmission. In other words, redundant packets for recovery are created on a data transmission side in advance and are transmitted together with original data packets. On a reception side, the original data packets are recovered using the redundant packets in a case where the packet loss occurs. Accordingly, reliability of data transmission improves.

As a technique regarding this recovery process of a data packet, a Real-time Transport Protocol (RTP) payload format using Forward Error Correction (FEC) is stipulated in RFC5109 (for example, refer to NPL 1).

In addition, an FEC scheme using Low Density Parity Check (LDPC) is stipulated in RFC5170 (for example, refer to NPL 2). Further, LDPC is one of FEC, and a calculation method (algorithm) using a matrix is described in RFC5170.

In addition, an RTP payload format for storing video data with an H.264 format is stipulated in RFC6184 (for example, refer to NPL 3).

### CITATION LIST

### Non Patent Literature

[NPL 1] “An RTP Payload Format for Generic Forward Error Correction”, IETF, RFC5109
[NPL 2] “Low Density Parity Check (LDPC) Staircase and Triangle Forward Error Correction (FEC) Schemes”, IETF, RFC5170
[NPL 3] “RTP Payload Format for H.264 Video”, IETF, RFC6184

### SUMMARY OF INVENTION

### Technical Problem

In the techniques disclosed in NPL 1 to NPL 3, it is difficult to reduce a data amount of redundant packets.

The present disclosure has been made in consideration of the above circumstances, and an object thereof is to provide a communication device and a communication method capable of reducing the data amount of redundant packets.

### Advantageous Effects of Invention

According to the present disclosure, it is possible to reduce a data amount of redundant packets.

### BRIEF DESCRIPTION OF DRAWINGS

FIG. 1 is a schematic diagram illustrating a configuration example of original data packets divided into a plurality of packets.

FIG. 2 is a schematic diagram illustrating a configuration example of a matrix used to create a redundant packet.

FIG. 3 is a schematic diagram illustrating a number and a variable of each element used to describe the matrix illustrated in FIG. 2.

FIG. 4 is a schematic diagram illustrating that a redundant packet (FEC1) is created by using the first row of the matrix illustrated in FIG. 2 in a method of the related art.

FIG. 5 is a schematic diagram illustrating that a redundant packet (FEC2) is created by using the second row of the matrix illustrated in FIG. 2 in a method of the related art.

FIG. 6 is a schematic diagram illustrating packets which are sent from a transmission side to a reception side.

FIG. 7 is a schematic diagram illustrating that a data packet which fails to be received is recovered using the first row of the matrix illustrated in FIG. 2 in the method of the related art.

FIG. 8 is a block diagram illustrating a configuration example of a data transmission device according to a first embodiment of the present disclosure.

FIG. 9 is a schematic diagram illustrating a rearrangement process of a data packet according to the first embodiment of the present disclosure.

FIG. 10 is a schematic diagram illustrating a correspondence relationship between a matrix and a data packet, related to Step 2 of FIG. 9.

FIG. 11 is a schematic diagram illustrating a specific example of a relationship between a data packet and a matrix when a redundant packet is created according to the first embodiment of the present disclosure.

FIG. 12 is a schematic diagram illustrating an example in which a length of a redundant packet is changed depending on whether or not a data packet rearrangement process is performed according to the first embodiment of the present disclosure.

FIG. 13 is a schematic diagram illustrating an example of a format of an RTP header according to the first embodiment of the present disclosure.

FIG. 14 is a schematic diagram illustrating an example of a format of an extension header of an RTP header according to the first embodiment of the present disclosure.

FIG. 15 is a schematic diagram illustrating a specific example of a format of an FEC header according to the first embodiment of the present disclosure.

FIG. 16 is a block diagram illustrating a configuration example of a data reception device according to the first embodiment of the present disclosure.

FIG. 17 is a schematic diagram illustrating a specific example of a packet recovery process according to the first embodiment of the present disclosure.

FIGS. 18A and 18B are schematic diagrams illustrating a result of a first simulation regarding a difference in a data reduction effect depending on whether or not a data packet rearrangement process is performed according to the first embodiment of the present disclosure.

FIGS. 19A and 19B are schematic diagrams illustrating a result of a second simulation regarding a difference in a data reduction effect depending on whether or not a data packet rearrangement process is performed according to the first embodiment of the present disclosure.

FIG. 20 is a flowchart illustrating a main operation example performed by the data transmission device according to the first embodiment of the present disclosure.

FIG. 21 is a flowchart illustrating a main operation example performed by the data reception device according to the first embodiment of the present disclosure.

FIG. 22 is a block diagram illustrating a configuration example of a data transmission device according to a second embodiment of the present disclosure.

FIG. 23 is a schematic diagram illustrating a first example of a format of an FEC header according to the second embodiment of the present disclosure.

FIG. 24 is a schematic diagram illustrating a second example of a format of an FEC header according to the second embodiment of the present disclosure.

FIG. 25 is a block diagram illustrating a configuration example of a data reception device according to the second embodiment of the present disclosure.

FIG. 26 is a flowchart illustrating a main operation example performed by the data transmission device according to the second embodiment of the present disclosure.

FIG. 27 is a block diagram illustrating a configuration example of a data transmission device according to a third embodiment of the present disclosure.

FIG. 28 is a schematic diagram illustrating a specific example of matrix state transition for performing a matrix rearrangement process in the data transmission device according to the third embodiment of the present disclosure.

FIG. 29 is a schematic diagram illustrating a specific example of a format of an FEC header according to the third embodiment of the present disclosure.

FIG. 30 is a block diagram illustrating a configuration example of a data reception device according to the third embodiment of the present disclosure.

FIG. 31 is a schematic diagram illustrating a result of a simulation regarding a difference in a data reduction effect depending on whether or not a data packet rearrangement process and a matrix rearrangement process are performed according to the third embodiment of the present disclosure.

FIG. 32 is a flowchart illustrating a main operation example performed by the data transmission device according to the third embodiment of the present disclosure.

FIG. 33 is a flowchart illustrating a main operation example performed by the data reception device according to the third embodiment of the present disclosure.

FIG. 34 is a block diagram illustrating a configuration example of a data transmission device according to a fourth embodiment of the present disclosure.

FIG. 35 is a schematic diagram illustrating a specific example of a format of an FEC header according to the fourth embodiment of the present disclosure.

FIG. 36 is a block diagram illustrating a configuration example of a data reception device according to the fourth embodiment of the present disclosure.

FIG. 37 is a flowchart illustrating a main operation example performed by the data transmission device according to the fourth embodiment of the present disclosure.

FIG. 38 is a flowchart illustrating a detailed specific example of a data packet rearrangement process according to the first embodiment of the present disclosure.

FIG. 39 is a flowchart illustrating a detailed specific example of a matrix rearrangement process according to the third embodiment of the present disclosure.

### DESCRIPTION OF EMBODIMENTS

Embodiments of the present disclosure will now be described with reference to the drawings.

(History of Having Obtained an Aspect of the Present Disclosure)

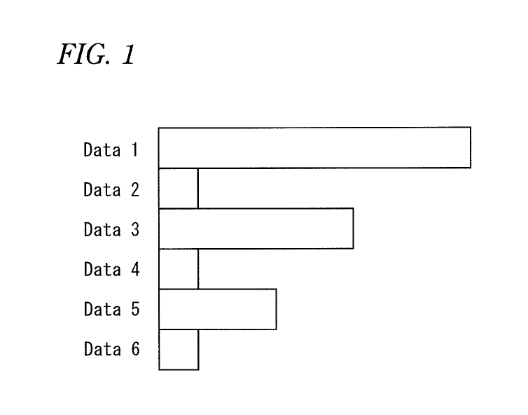

An outline of the techniques based on NPL 1 to NPL 3 will be described briefly with reference to FIGS. 1 to 7.

FIG. 1 illustrates an example of original data packets to be transmitted. There are six data packets Data1, Data2, Data3, Data4, Data5 and Data6. In FIG. 1, a case where data lengths of the respective packets are not constant is assumed. Redundant packets are created using these original data packets.

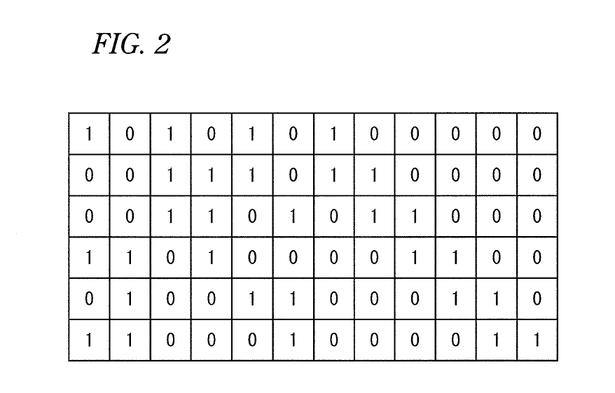

FIG. 2 illustrates a matrix used to create redundant packets. Each element of the matrix is either “1” or “0”. A rule for generating the matrix is disclosed in NPL 3. A transmission side and a reception side have or generate the same matrix, and thus original data packets can be recovered using redundant packets.

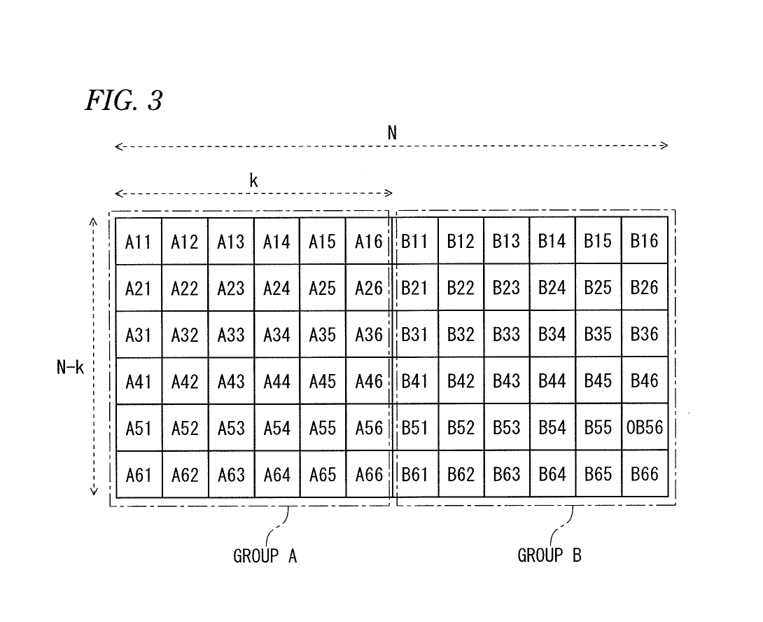

FIG. 3 is a diagram illustrating each element and a configuration of the matrix. The matrix illustrated in FIG. 3 will be described by dividing the matrix into matrices of a group A and a group B. The matrix (B11, B12, . . . , B65, and B66) of the group B is a square matrix of which the number of rows and the number of columns are the same as each other. In a case where each element of the matrix is denoted by Bxy using a variable x indicating a row direction position and a variable y indicating a column direction position, as illustrated in FIG. 2, each element having a relationship of x=y or x=y+1 is 1, and the other elements are 0.

In the matrix (A11, A12, . . . , A65, and A66) of the group A, the number of rows is (N−k), and the number of columns is k. A value of k is the same as the number of original data packets. In a case of FIG. 2, k=6. A value of N depends on the number of redundant packets to be generated.

In FIG. 2, a case where the number of redundant packets is the same as the number of original data packets is assumed, and thus N=12. The number of redundant packets is indicated by N−k, and, in a case of FIG. 2, N−k=6.

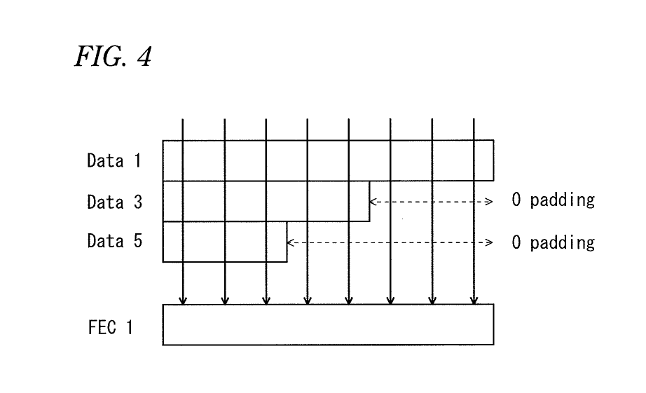

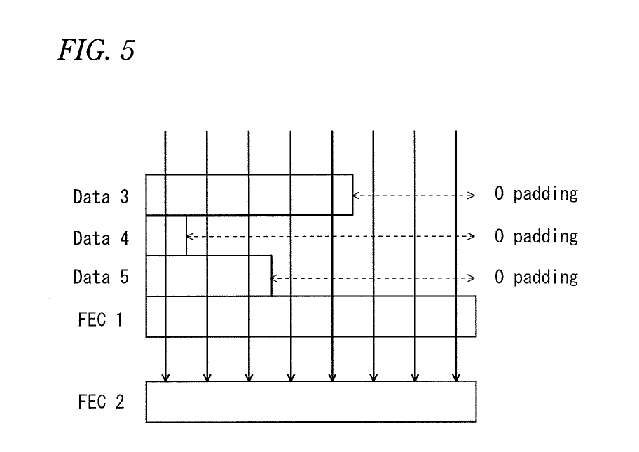

Next, a method of the related art of creating a redundant packet will be described with reference to FIGS. 4 and 5.

In FIG. 4, a redundant packet (FEC1) is created using the first row of the matrix illustrated in FIG. 2. Each element Axy (where x is a variable indicating a row direction position and y is a variable indicating a column direction position) of the group A is information used to identify an original data packet which is used to create a redundant packet. The column of the management of the group A and an original data packet correspond to each other in a one-to-one relationship.

In the first row of the matrix of the group A, the respective elements of A11, A13, and A15 are “1”, and thus a redundant packet is created using Data1, Data3, and Data5 corresponding to the first column, the third column, and the fifth column. A created redundant packet corresponds to the column of the matrix of the group B. In FIG. 2, the element B11 is “1”, and thus a first redundant packet is created as FEC1 from the first row of the matrix.

A data length of FEC1 is the same as a data length of Data1 which is the longest in FIG. 1. In the respective data packets Data1, Data3 and Data5, XOR (exclusive OR) calculation is performed on bits at the same position. A calculation result is data of FEC1.

In the example of FIG. 4, Data1, Data3, and Data5 have data lengths different from each other. In a case where lengths of processed data items are different from each other, in order to align a data length, short data is padded with 0 so as to match the longest data, and then the calculation is performed. In other words, each bit at a position where there is no data is regarded as “0”, and then the XOR calculation is performed.

Next, a method of creating a second redundant packet FEC2 will be described with reference to FIG. 5.

When FEC2 is created, the second row of the matrix of FIG. 2 is used. In this case, the respective elements A23, A24, A25 and B21 of the matrices are “1”, and thus the redundant packet FEC2 is created using the three data packets Data3, Data4 and Data5, and the redundant packet FEC1.

A data length of FEC2 is the same as a data length of a packet which is the longest of Data3, Data4, Data5, and FEC1. In the example of FIG. 5, the data length of FEC1 is the largest, and thus the data length of FEC2 is the same as that of FEC1.

XOR calculation is performed on bits at the same position of Data3, Data4, Data5 and FEC1 so as to create data of FEC2. In this case, the data lengths of Data3, Data4 and Data 5 is smaller than the data length of FEC1, each bit at a position where there is no data is set to 0, and then the XOR calculation is performed.

The number of rows of the matrix illustrated in FIG. 2 is 6. The above-described processes (the processes in FIGS. 4 and 5) are performed on each row so as to create six redundant packets (FEC1, FEC2, FEC3, FEC4, FEC5, and FEC6).

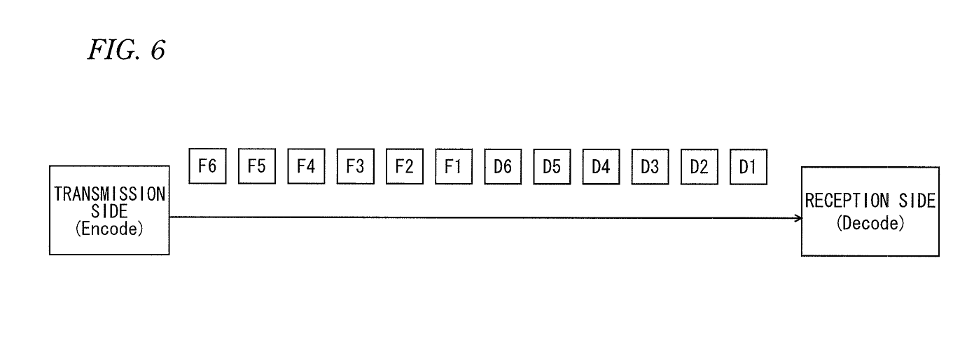

FIG. 6 illustrates a state in which packets are transmitted from a transmission side communication device (hereinafter, simply referred to as a transmission side) to a reception side communication device (hereinafter, simply referred to as a transmission side). In FIG. 6, the original data packets (Data1, Data2, Data3, Data4, Data5, and Data6) and the redundant packets (FEC1, FEC2, FEC3, FEC4, FEC5, and FEC6) are sequentially transmitted.

In a case where there is a data packet which cannot be received among the original data packets, the reception side recovers the data packet which cannot be received using the redundant packet. Therefore, the reception side checks whether or not all the original data packets are received. In order to check the reception of the data packets, the reception side generates the same matrix as that of the transmission side.

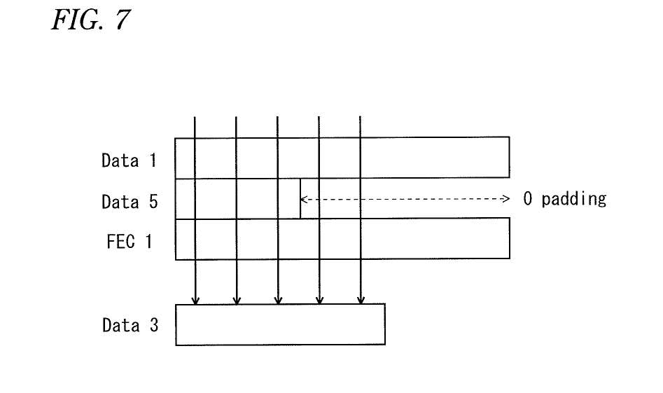

As a case where an original data packet cannot be received, a case where only Data3 cannot be received will be described as an example. In FIG. 2, the respective elements A13, A23 and A33 are “1” in the third column of the matrix of the group A. For this reason, Data3 can be recovered using any one of the first row, the second row, and the third row of the matrix. Here, an example of performing recovery using the first row will be described with reference to FIG. 7.

The first row of the matrix of FIG. 2 illustrates that FEC1 is created through XOR calculation using Data1, Data3, and Data5. Therefore, conversely, XOR calculation is performed on Data1, Data5, and FEC1, thereby recovering data of Data3.

In addition, data length information of Data3 necessary to recover Data3 is calculated using information “Length Recovery” added to the redundant packet FEC1. “Length Recovery” is described in NPL 1, and is thus briefly described here.

In the example of FIG. 7, the transmission side performs XOR calculation on data length values of Data1, Data3 and Data5 so as to calculate a value of “Length Recovery”, and adds the value to a header of FEC1. Conversely, the reception side performs XOR calculation on the value of “Length Recovery” and the data length information of Data1 and Data5 so as to calculate a data length of Data3.

However, in a case where communication is performed according to the above-described method, if the transmission side creates and transmits redundant packets for data packets, and the reception side recovers a data packet, the redundant packets are transmitted along with the original data packets.

In a case where a data amount of redundant packets is large, a total data amount to be transmitted increases. In the above-described method, a packet length of a created redundant packet is determined by a length of the longest packet of a plurality of original data packets.

For example, in a case where video data is transmitted, a plurality of data packets of which lengths are not constant are created, and divided video data items are stored in the data packets. Therefore, redundant packets (for example, FEC packets) created during transmission may have different lengths. For this reason, when the redundant packets are generated and recovered, a data calculation amount may increase or a communication load may increase.

Hereinafter, a description will be made of a communication device and a communication method capable of reducing a data amount of redundant packets.

In the present embodiment, it is mostly assumed that an RTP protocol for streaming reproduction of videos or sounds is used as a protocol for transmitting data. A data packet of the RTP protocol is also described as an RTP data packet. In addition, forward error correction (FEC) is performed using a redundant packet, and thus this redundant packet is also described as a FEC packet. The present disclosure is applicable to data packets other than the RTP data packet or redundant packets other than the FEC packet in the same manner.

The communication device according to the present embodiment is applicable to various data communication apparatuses such as a telephone, a transmitter and a receiver of television signals, a transmitter and a receiver of radio signals, a mobile phone, a smart phone, a tablet, a PC, a camera with a communication function, and a video camera with a communication function.

### First Embodiment

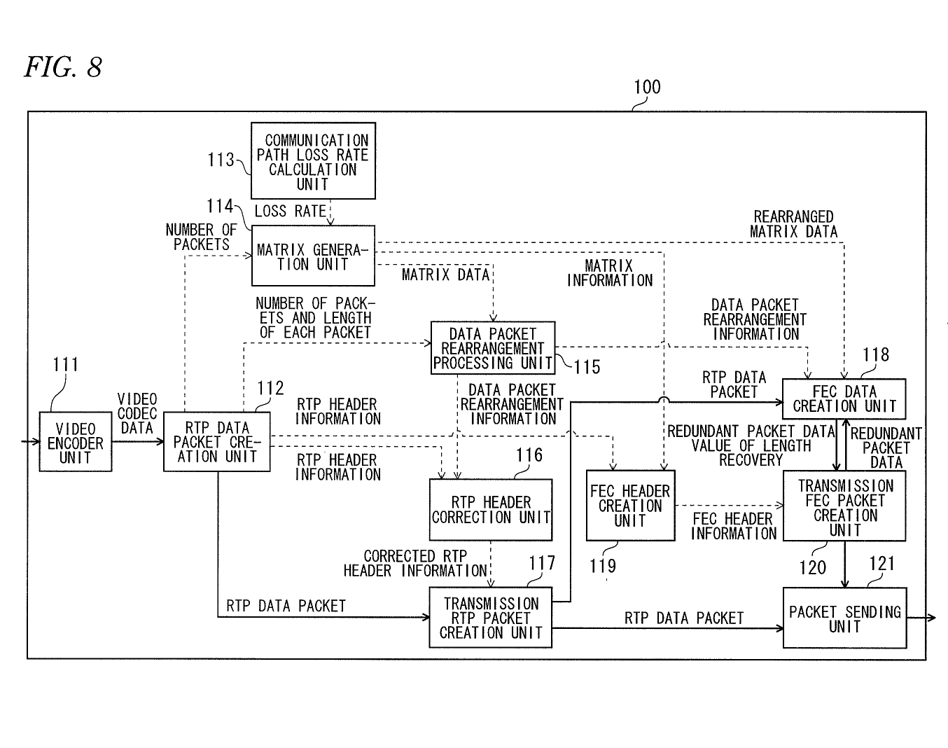

A communication system according to the present embodiment will be described below with reference to FIGS. 8 to 21 and 38. In this communication system, data is transmitted and received via a predetermined communication path between a data transmission device 100 and a data reception device 150. The data transmission device 100 and the data reception device 150 are examples of the communication device.

(Transmission Side)

The data transmission device 100 will be described.

FIG. 8 is a block diagram illustrating a configuration example of the data transmission device 100 according to the first embodiment of the present disclosure.

As illustrated in FIG. 8, the data transmission device 100 includes a video encoder unit 111, an RTP data packet creation unit 112, a communication path loss rate calculation unit 113, a matrix generation unit 114, a data packet rearrangement processing unit 115, an RTP header correction unit 116, a transmission RTP packet creation unit 117, an FEC data creation unit 118, an FEC header creation unit 119, a transmission FEC packet creation unit 120, and a packet sending unit 121.

The video encoder unit 111 receives video input data such as moving images or still images from a video camera or the like, and encodes the data according to an algorithm stipulated in H.264 or the like. The video encoder unit 111 delivers video codec data having undergone the encoding process to the RTP data packet creation unit 112.

The RTP data packet creation unit 112 receives the video codec data from the video encoder unit 111 so as to create an RTP data packet. For example, it is expected that a single picture data item is encoded so as to be divided into a plurality of data items, and the plurality of data items are used as a plurality of RTP data packets.

The example of FIG. 1 illustrates that data is encoded according to H.264, and six data packets are obtained by dividing the data at slice boundaries.

In addition, the RTP data packet creation unit 112 notifies the matrix generation unit 114 of the number of created data packets. This value corresponds to a value of k in the above-described description. Further, the RTP data packet creation unit 112 notifies the data packet rearrangement processing unit 115 of the number “k” of packets and a packet length of each data packet.

Furthermore, the RTP data packet creation unit 112 creates an RTP header, and notifies the RTP header correction unit 116 and the FEC header creation unit 119 of information regarding the RTP header. The RTP header information is header information added to the RTP data packet.

In addition, the RTP data packet creation unit 112 notifies the transmission RTP packet creation unit 117 of the RTP data packet. Further, instead of notifying of the RTP data packet, a notification of pointer information indicating a location where the RTP data packet is held may be sent.

The communication path loss rate calculation unit 113 calculates a packet loss (simply referred to as a loss) rate on the communication path. Specifically, information regarding the loss rate is received from the data reception device 150. In addition, for example, the communication path loss rate calculation unit 113 may calculate packet loss information by itself on the basis of a retransmission request from the data reception device 150.

The matrix generation unit 114 generates a matrix for creating a redundant packet on the basis of the information regarding the number of packets from the RTP data packet creation unit 112 and the information regarding the loss rate from the communication path loss rate calculation unit 113. An algorithm for generating a matrix in the matrix generation unit 114 may employ a well-known method (for example, the method disclosed in NPL 2). The matrix generation unit 114 generates a matrix in a method described below.

As a method in which the transmission side and the reception side share a value of N, a value of k, and a value of Seed, various methods are considered. For example, there is a method of adding the values as header information (FEC header information) of a redundant packet. Alternatively, there may be a method in which the values are determined in advance.

In order to generate a matrix, a value of N, a value of k, and a value of Seed are necessary. As a value of k indicating the number of original data packets, the number k of data packets from the RTP data packet creation unit 112 is used.

The matrix generation unit 114 calculates a total number N of packets including the number of redundant packets and the number of data packets on the basis of the loss rate from the communication path loss rate calculation unit 113. In a case where the loss rate is high, it is possible to increase a recovery rate in the data reception device 150 by increasing the total number N of packets. If the loss rate is low, the total number N of packets may be reduced.

The number of redundant packets is indicated by “N−k”, and satisfies N≧k. In addition, the total number N of packets is determined by the data transmission device 100, and a notification thereof is sent to the data reception device 150.

A value of Seed may be fixed or may be dynamically changed. The matrix generation unit 114 may adjust Seed, for example, so that a recovery rate increases. In a case where Seed is dynamically changed, the data reception device 150 is also notified of a value of Seed in the same manner as the total number N of packets.

The matrix generation unit 114 notifies the data packet rearrangement processing unit 115 and the FEC data creation unit 118 of the generated matrix data. In addition, instead of a notification of the matrix data, a notification of pointer information indicating a position where the matrix data is held may be sent.

Further, the matrix generation unit 114 notifies the FEC header creation unit 119 of the matrix information. The matrix information includes respective values of the total number N of packets, the number k of data packets, and Seed.

The data packet rearrangement processing unit 115 receives information regarding the matrix data from the matrix generation unit 114. In addition, the number k of data packets and packet length information of each packet are received from the RTP data packet creation unit 112.

The data packet rearrangement processing unit 115 performs a rearrangement process of data packets of rearranging the RTP data packets on the basis of a sum total of packet lengths (packet sizes) of the redundant packets. Specifically, the order of data packets is rearranged so that a sum total of packet lengths (packet sizes) of the redundant packets has a small value.

A search method for rearrangement of data packets may employ a heuristic method. In other words, the data packet rearrangement processing unit 115 may calculate data lengths of redundant packets to be created in all cases, and may find an order of data packets to be arranged in which a sum total of data lengths is the smallest in all the cases. A specific example related to rearrangement of data packets will be described later.

The data packet rearrangement processing unit 115 notifies the FEC data creation unit 118 and the RTP header correction unit 116 of data packet rearrangement information including a result of performing the rearrangement process of data packets.

The FEC data creation unit 118 creates redundant packets (FEC packets) on the basis of the matrix data, the data packets, and the rearrangement information of the data packets. In addition, there is a case where a redundant packet which has already been created is used to create a redundant packet. In this case, the transmission FEC packet creation unit 120 receives a redundant packet so as to create a new redundant packet.

Further, the FEC data creation unit 118 calculates a value “Length recovery” when creating a redundant packet. A method of calculating “Length recovery” is disclosed in, for example, NPL 1. “Length recovery” is information for recovering a packet length of a lost packet. In other words, “Length recovery” is one of packet length information for recovering a packet length of an incorrect packet which is lost or is not correctly received.

In addition, the incorrect packet indicates a packet which is lost during transmission and a packet which causes a data error during transmission. A packet which causes a data error during transmission is treated equivalently to a packet which is lost during transmission in the reception side in a case where the reception side detects the occurrence of errors and cannot correct the errors.

The FEC data creation unit 118 calculates “Length recovery” by performing XOR calculation on respective packet length values of packets for creating redundant packets.

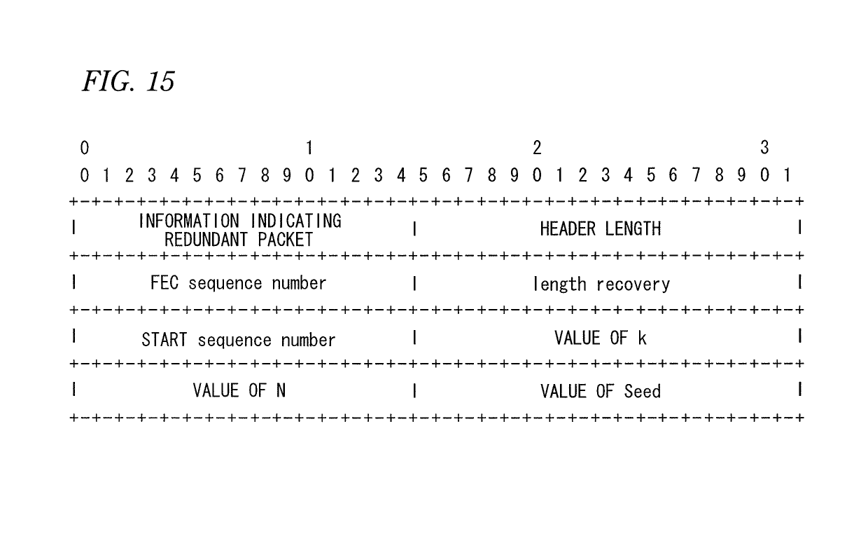

The FEC data creation unit 118 notifies the transmission FEC packet creation unit 120 of data (redundant packet data) of the created redundant packets, the value of “Length Recovery”, and information indicating what number an FEC packet is. This notification may be a notification of pointer information indicating a destination where the values are preserved. In addition, the information indicating what number of FEC packet corresponds to “FEC Sequence Number” of FIG. 15.

The RTP header correction unit 116 corrects RTP header information by using the RTP header information created by the RTP data packet creation unit 112 and the data packet rearrangement information generated by the data packet rearrangement processing unit 115. The data reception device 150 can recover a lost data packet by using the corrected RTP header information.

The transmission RTP packet creation unit 117 receives the RTP data packets from the RTP data packet creation unit 112, and receives the corrected RTP header information from the RTP header correction unit 116. In addition, the transmission RTP packet creation unit 117 creates RTP data packets in which the corrected RTP header information is added to the RTP data packets.

The transmission RTP packet creation unit 117 delivers the created RTP data packets to the FEC data creation unit 118 and the packet sending unit 121. At this time, the RTP data packet itself may be delivered, or a pointer indicating a position where corresponding data is held may be delivered. A process of reading and writing data on a memory requires time, and thus a process using a pointer operation may be more efficient.

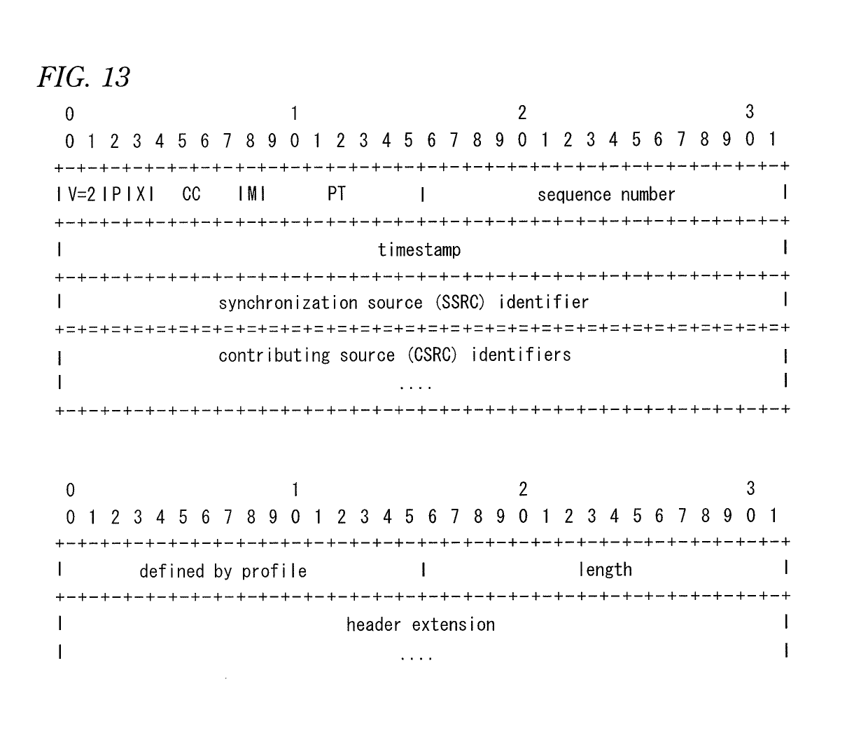

The FEC header creation unit 119 receives the matrix information from the matrix generation unit 114, and receives the RTP header information from the RTP data packet creation unit 112, so as to create a header of a redundant packet (FEC header). The RTP header information includes a sequence number (refer to FIG. 13) for identifying the order of RTP headers. The FEC header creation unit 119 delivers the created FEC header information to the transmission FEC packet creation unit 120. In addition, pointer information of the FEC header information may be delivered instead of the FEC header information.

The transmission FEC packet creation unit 120 receives the data of redundant packets, the value of “Length recovery”, and the value of “FEC Sequence Number” from the FEC data creation unit 118. In addition, the transmission FEC packet creation unit 120 receives the FEC header information from the FEC header creation unit 119.

The transmission FEC packet creation unit 120 creates redundant packets by using the data of redundant packets, the value of “Length recovery”, the value of “FEC Sequence Number”, and the FEC header information. In other words, the transmission FEC packet creation unit 120 creates redundant packets (FEC packets) in which the FEC header information is added to the data of redundant packets (FEC packets).

The transmission FEC packet creation unit 120 delivers the created redundant packets to the packet sending unit 121. In addition, the redundant packet itself may be delivered, or, alternatively, pointer information indicating a position where the redundant packet is held may be delivered.

In addition, there is a case where a redundant packet is further generated using a redundant packet created by the transmission FEC packet creation unit 120. In this case, data of the redundant packet is delivered from the transmission FEC packet creation unit 120 to the FEC data creation unit 118. In relation to this delivery, pointer information indicating a position where data of the created redundant packet is preserved may be delivered.

The packet sending unit 121 sends the RTP data packets created by the transmission RTP packet creation unit 117 and the redundant packets created by the transmission FEC packet creation unit 120 to the communication path.

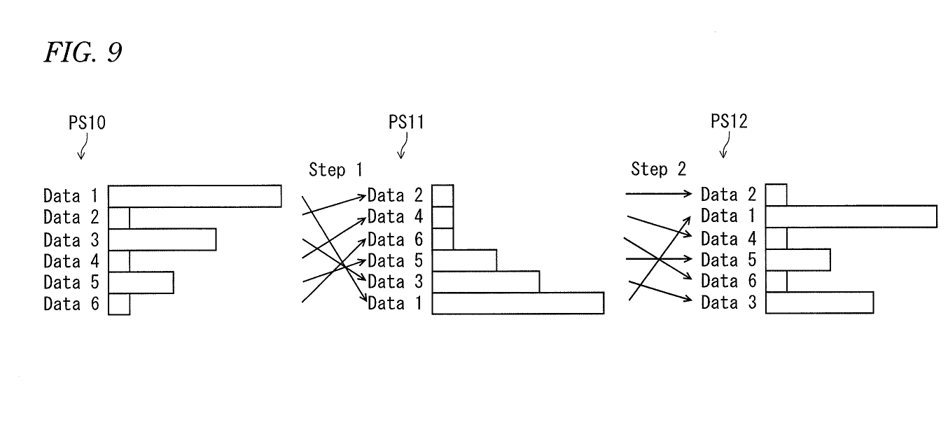

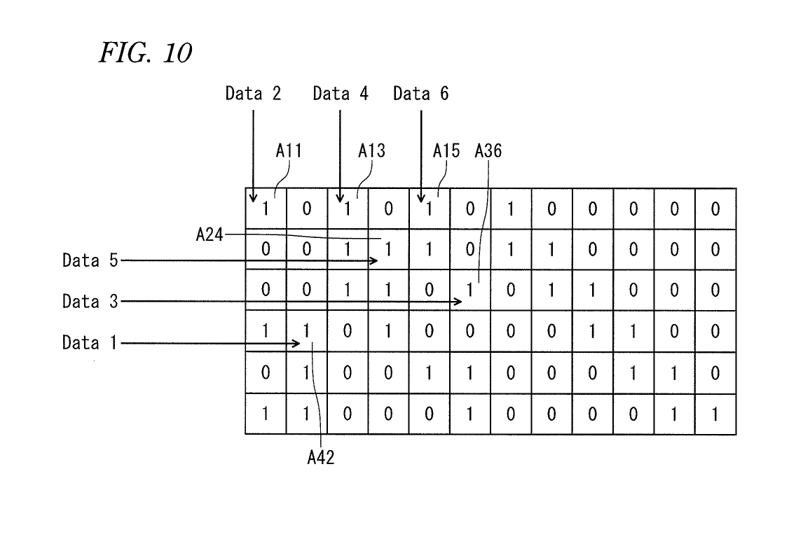

Next, with reference to FIGS. 9 and 10, a description will be made of an example of the data packet rearrangement process performed by the data packet rearrangement processing unit 115.

First, as in Step 1, the data packet rearrangement processing unit 115 arranges data packets in order of a smaller data length.

Successively, as in Step 2, the data packet rearrangement processing unit 115 performs a rearrangement process so as to be suitable for the elements of the management. This will be described using a value of the element Axy of the management of the group A illustrated in FIG. 3. The data packet rearrangement processing unit 115 searches for a minimal value of x for each value of y when the element Axy is “1”.

In addition, there is necessarily an element which is “1” in each column of the matrix. This is because the element is required to be used as data for an XOR calculation process when a redundant packet is created, in order to recover a packet when the packet is lost. In a case where there is no element which is “Axy=1” in a certain column, if a data packet assigned to the column is lost, the data packet cannot be recovered.

Next, the data packet rearrangement processing unit 115 arranges Axy in ascending order of the searched-for minimal values of x, and assigns the data packets arranged in the short order in Step 1 to respective corresponding columns.

A description will be made using a specific example. FIG. 9 illustrates an example of a case where a data packet group PS10 to be input has the same order as the order of the data packets (Data1 to Data6) similar to FIG. 1. In FIG. 9, in Step 1, the data packet group PS10 is arranged in order of a smaller data length. In Step 1, in a case where data lengths are the same as each other, a data packet of which order is originally before is arranged on the front side (the upper side in FIG. 9).

The order of a data packet group PS11 which is output as a result of Step 1 is (Data2, Data4, Data6, Data5, Data3, and Data1).

Next, assuming that a configuration of a matrix for creating a redundant packet and each element of the matrix is the same as in FIGS. 2 and 3, a process in Step 2 of FIG. 9 will be described in detail.

In Step 2, the data packet rearrangement processing unit 115 searches for a minimal value of x for each value of y when the element Axy is “1”. In the first column (y=1) of the matrix, A11 is the minimum (x=1). Similarly, A42, A13, A24, A15, and A36 are respectively minimal elements in the second column, the third column, the fourth column, the fifth column, and the sixth column of the matrix.

When these elements are arranged in order of smaller x, A11, A13, A15, A24, A36, and A42 are arranged in this order. The data packet rearrangement processing unit 115 correlates the respective elements (A11, A13, A15, A24, A36, and A42) with the data packet group PS11 arranged in the short order in Step 1.

In other words, as illustrated in FIG. 10, combinations of (A11, Data2), (A13, Data4), (A15, Data6), (A24, Data5), (A36, Data3) and (A42, Data1) occur. When these combinations are rearranged in order of columns (in order of smaller y), (A11, Data2), (A42, Data1), (A13, Data4), (A24, Data5), (A15, Data6), and (A36, Data3) are arranged in this order.

In other words, due to the rearrangement in Step 2, Data2, Data1, Data4, Data5, Data6, and Data3 are arranged in this order as in the data packet group PS12 illustrated in FIG. 9.

FIG. 10 is a diagram illustrating Step 2 of the data packet rearrangement process. The data packet group PS11 which is arranged in order of a smaller data length includes Data2, Data4, Data6, Data5, Data3, and Data1 in FIG. 10. The column in which an element is “1” from the upper row of the matrix is found, and data with a smaller data length is assigned thereto.

Specifically, since A11 is “1”, Data2 is assigned to the first column. Successively, since A12 is “0”, the next process continues, and since A13 is “1”, Data4 is assigned to the third column. Subsequently, since A14 is “0”, the next process continues, and since A15 is “1”, Data6 is assigned to the fifth column. Next, since A16 is “0”, the next process continues, and the first row of the matrix Axy is checked to the end, and the process proceeds to the second row.

In the second row, since A24 is “1”, Data5 is assigned to the fourth column. Although A23 and A25 are “1”, the first row is already “1”, and thus data is not assigned.

Successively, a column in which an element is “1” is searched for among unassigned columns through the same process, and A36 is “1”, and thus Data3 is assigned to the sixth column. Finally, A42 is “1”, and thus Data1 is assigned to the second column.

When the data assigned to the respective columns is rearranged in order of the columns, Data2, Data1, Data4, Data5, Data6, and Data3 are arranged in this order, that is, are arranged in order of the data packet group PS12 of FIG. 9.

Next, a description will be made of a process of creating a redundant packet, performed by the FEC data creation unit 118.

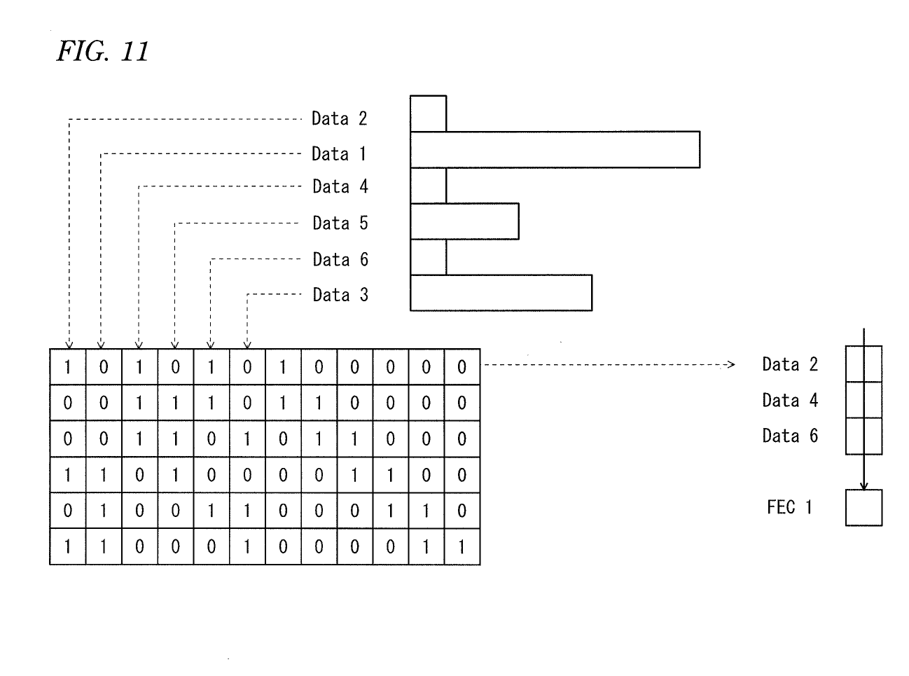

FIG. 11 illustrates a correspondence relationship between a matrix and data packets assigned to respective columns of the matrix, and further a redundant packet FEC1 created using the first row of the matrix. In the example of FIG. 11, since a case where a redundant packet is created from the result (the order of PS12 in FIG. 9) of the data packet rearrangement process is assumed, an arrangement order of data packets corresponding to the respective columns of the matrix is different from the example of FIG. 4. The matrix of FIG. 11 is the same as the matrix illustrated in FIG. 2.

In relation to a process using the first row of the matrix, an XOR process is performed using data packets Data2, Data4 and Data6 corresponding to the respective elements of which content of the matrix is “1”. The first redundant packet (FEC1) is created using the process result. When the result of FIG. 11 is compared with the result of FIG. 4, a data length of the redundant packet (FEC1) is smaller. This is because, when a redundant packet is created without rearranging data packets, the redundant packet is created from Data1, Data3, and Data5 with a large data length as in FIG. 4, and thus a data length of the redundant packet is also large.

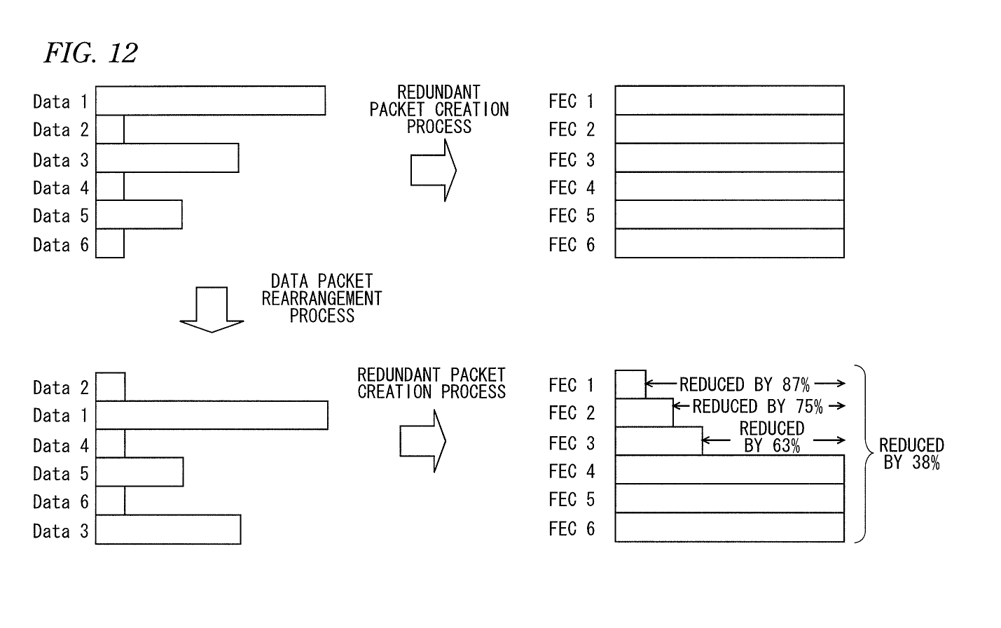

FIG. 12 illustrates a comparison result between data lengths in a case where the data packet rearrangement process is performed and in a case where the data packet rearrangement process is not performed. A matrix for creating a redundant packet uses the matrix as illustrated in FIG. 2.

With reference to FIG. 12, data lengths of the redundant packets (FEC1, FEC2, and FEC3) can respectively be reduced by 87%, 75%, and 63% due to the data packet rearrangement process, and thus can be reduced by 38% in comparison of a total data amount of adding up the six packets. As above, the data packet rearrangement process is performed before a redundant packet is created, and thus it is possible to effectively reduce a data amount of redundant packets.

Next, a header of each packet will be described.

FIG. 15 is a diagram illustrating an example of a format of an FEC header. In addition, a header of a packet indicates a region which holds a variety of information necessary to manage the packet, and is generally added to a leading part of a packet body so as to be transmitted integrally with the packet body.

The FEC header includes information indicating that the packet is a redundant packet. In addition, information regarding a header length is included. Further, a value of “FEC sequence Number” is included. The value of “FEC sequence Number” is information indicating what number the redundant packet is. The value of “FEC sequence Number” is determined by the FEC data creation unit 118, and is assigned to the header by the transmission FEC packet creation unit 120.

In addition, the FEC header includes a value of “Length recovery”. The value of “Length recovery” is a value obtained by performing XOR calculation on a data packet used when creating a redundant packet and a value of a packet length of the redundant packet. The value of “Length recovery” is calculated by the FEC data creation unit 118 and is assigned by the transmission FEC packet creation unit 120.

In addition, the FEC header includes “Start sequence number”, a value of k, a value of N, and a value of Seed. Respective pieces of information received from the FEC header creation unit 119 are assigned to the header as these values.

In addition, an implementation can be performed so that the transmission FEC packet creation unit 120 assigns “Start sequence number”. In this case, delivery of RTP header information from the RTP data packet creation unit 112 to the FEC header creation unit 119 may be omitted.

FIG. 13 is a diagram illustrating an example of a format of the RTP header. This format is stipulated in “IETF RFC3550 “RTP: A Transport Protocol for Real-Time Applications””.

The data reception device 150 checks “timestamp” and “sequence number”. Packets created from a single picture have “timestamp” set to the same value. In addition, integers which increase by 1 are set in “Sequence number”. For this reason, a packet loss can be detected by checking “sequence number”.

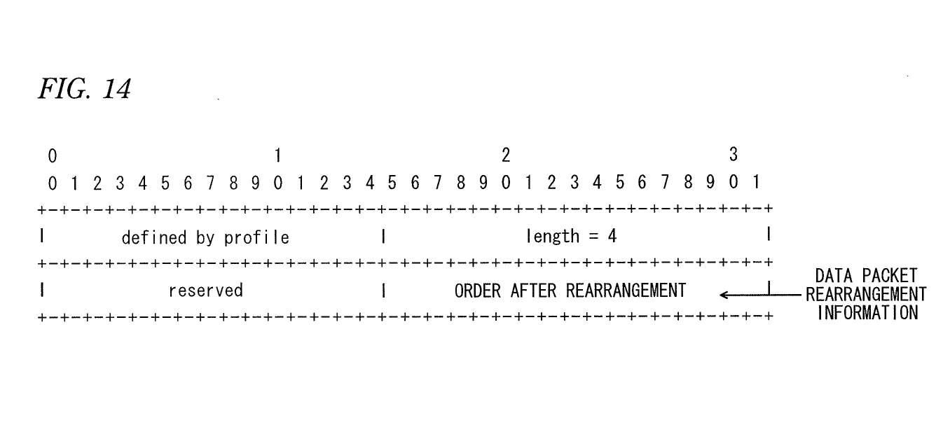

FIG. 14 is a diagram illustrating an example of a format of a part of an extension header (RTP extension header: “header extension” of FIG. 13) of the RTP header. The extension header of the RTP header includes data packet rearrangement information as information indicating order after data packets are rearranged.

For example, in a case where data is rearranged in the order illustrated in FIG. 12, since Data1 is the second data packet, the RTP header correction unit 116 sets the value “2” in the region of the RTP extension header indicating the order after rearrangement. Similarly, in relation to Data2, the RTP header correction unit 116 sets the value “1” in the region of the extension header of the RTP header indicating the data packet rearrangement information.

In addition, information indicating an extension header which indicates the data packet rearrangement information is set in the region “defined by profile”. A set value thereof is not particularly limited. There is also no particular limitation on the region “Reserved”. The RTP header correction unit 116 notifies the transmission RTP packet creation unit 117 of the corrected RTP header information created.

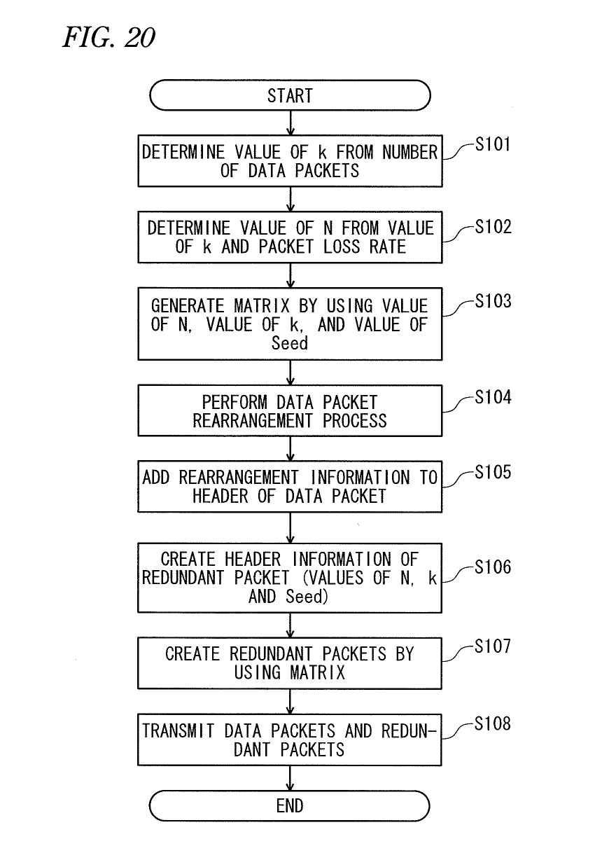

Next, a flow of the overall process in the data transmission device 100 will be described with reference to a flowchart illustrated in FIG. 20.

First, the RTP data packet creation unit 112 receives video codec data from the video encoder unit 111 so as to create an RTP data packet. The number of RTP data packets is k (step S101).

Subsequently, the matrix generation unit 114 determines the total number N of packets including the number of redundant packets by using the number k of data packets from the RTP data packet creation unit 112 and a loss rate from the communication path loss rate calculation unit 113 (step S102).

Subsequently, the matrix generation unit 114 determines a value of Seed for generating a matrix. For example, a value of Seed may be adjusted so that a recovery rate increases. The matrix generation unit 114 generates a matrix on the basis of the total number N of packets, the number k of data packets, and Seed (step S103).

Next, the data packet rearrangement processing unit 115 performs a data packet rearrangement process (step S104).

Next, the RTP header correction unit 116 adds data packet rearrangement information received from the data packet rearrangement processing unit 115 to the RTP header (step S105). Accordingly, the RTP header is corrected. The transmission RTP packet creation unit 117 creates RTP data packets to be transmitted, using the corrected RTP header and the RTP data packets.

Successively, the FEC header creation unit 119 creates FEC header information on the basis of matrix information from the matrix generation unit 114 and the RTP header information from the RTP data packet creation unit 112 (step S106).

Successively, the FEC data creation unit 118 creates a redundant packet on the basis of the matrix generated by the matrix generation unit 114, the RTP data packets created by the transmission RTP packet creation unit 117, and the data packet rearrangement information created by the data packet rearrangement processing unit 115 (step S107).

In addition, the FEC data creation unit 118 calculates “Length recovery” on the basis of packet length information of a packet used to create the redundant packet. Further, the FEC data creation unit 118 delivers values of “FEC Sequence Number” and “Length recovery” included in the FEC header information to the transmission FEC packet creation unit 120.

In addition, the transmission FEC packet creation unit 120 receives the FEC header information from the FEC header creation unit 119, and the value of “Length recovery”, “FEC Sequence Number” and data of redundant packets from the FEC data creation unit 118, so as to create redundant packets to be transmitted.

Further, the order of the processes in steps S106 and S107 illustrated in FIG. 20 may be reversed.

Next, the packet sending unit 121 receives the RTP data packets from the transmission RTP packet creation unit 117 and the redundant packets from the transmission FEC packet creation unit 120 and transmits the packets to the data reception device (step S108).

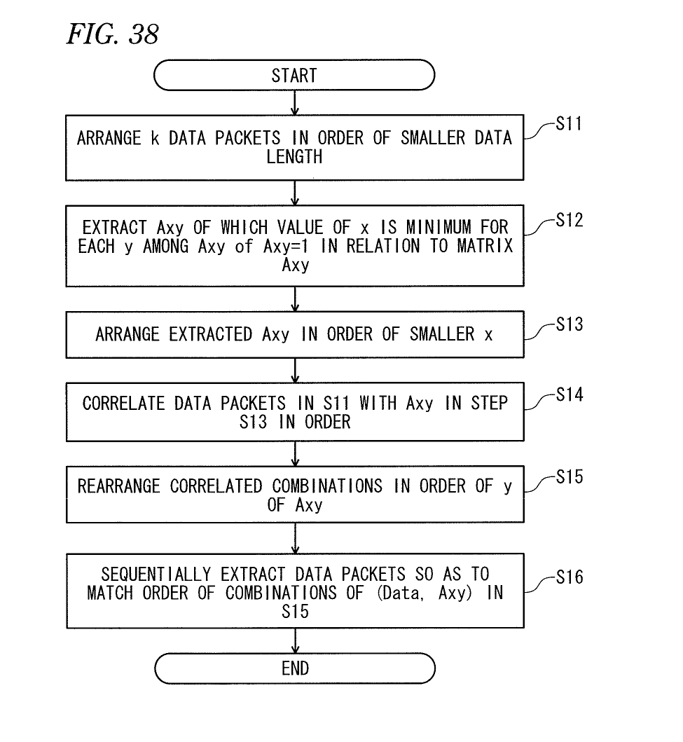

FIG. 38 is a flowchart illustrating a detailed example of the data packet rearrangement process.

First, the data packet rearrangement processing unit 115 arranges k data packets in order of a smaller data length (step S11). For example, in a case where the six data packets illustrated in FIG. 1 are processed, and, as a result, the data packets are arranged in order of Data2, Data4, Data6, Data5, Data3, and Data1.

Next, the data packet rearrangement processing unit 115 extracts the element Axy of which a value of x is the minimum for each y among Axy which is “1” in relation to the respective elements (Axy) of the matrix (step S12).

For example, in a case of using a result of rearranging the data packet group of FIG. 1 and the matrix illustrated in FIGS. 2 and 3, the following result can be obtained. (y, Axy)=(1, A11), (2, A42), (3, A13), (4, A24), (5, A15), and (6, A36)

Successively, the data packet rearrangement processing unit 115 rearranges the respective elements Axy extracted in step S12 in order of smaller x (step S13). For example, as a result, the elements are arranged in order of A11, A13, A15, A24, A36, and A42.

Next, the data packet rearrangement processing unit 115 respectively correlates the data packets as a result of step S11 with the elements Axy as a result of step S13 in order (step S14). For example, the following result can be obtained. (Data2, A11), (Data4, A13), (Data6, A15), (Data5, A24), (Data3, A36), and (Data1, A42)

Next, the data packet rearrangement processing unit 115 rearranges the combinations correlated with each other in step S14 in order centering on y of each element Axy (step S15). For example, the following result can be obtained after the rearrangement is performed. (Data2, A11), (Data1, A42), (Data4, A13), (Data5, A24), (Data6, A15), and (Data3, A36)

Successively, the data packet rearrangement processing unit 115 sequentially extracts a data packet group so as to match the order of the combinations of (Data, Axy) obtained as a result of step S15 (step S16). For example, order of data packets to be extracted is consequently order of Data2, Data1, Data4, Data5, Data6, and Data3.

As above, in the data transmission device 100, when data packets are assigned to respective columns of matrix data, the data packet rearrangement processing unit 115 rearranges the data packets so that, as a row of the matrix data is located at a further upper position, a packet length of a data packet to be assigned is reduced.

According to the data transmission device 100, it is possible to reduce a data amount of redundant packets. Therefore, a data calculation amount is reduced when redundant packets are created, and thus it is possible to reduce a processing load on the data transmission device 100. In addition, a data amount sent to the communication path (transmission path) is also reduced, and thus it is possible to efficiently use a band of the transmission path. For example, even in a case where a band of the transmission path is shared by a plurality of users or a case where a band of the transmission path is narrow, it is possible to perform high speed communication with few errors.

(Reception Side)

The data reception device 150 will be described.

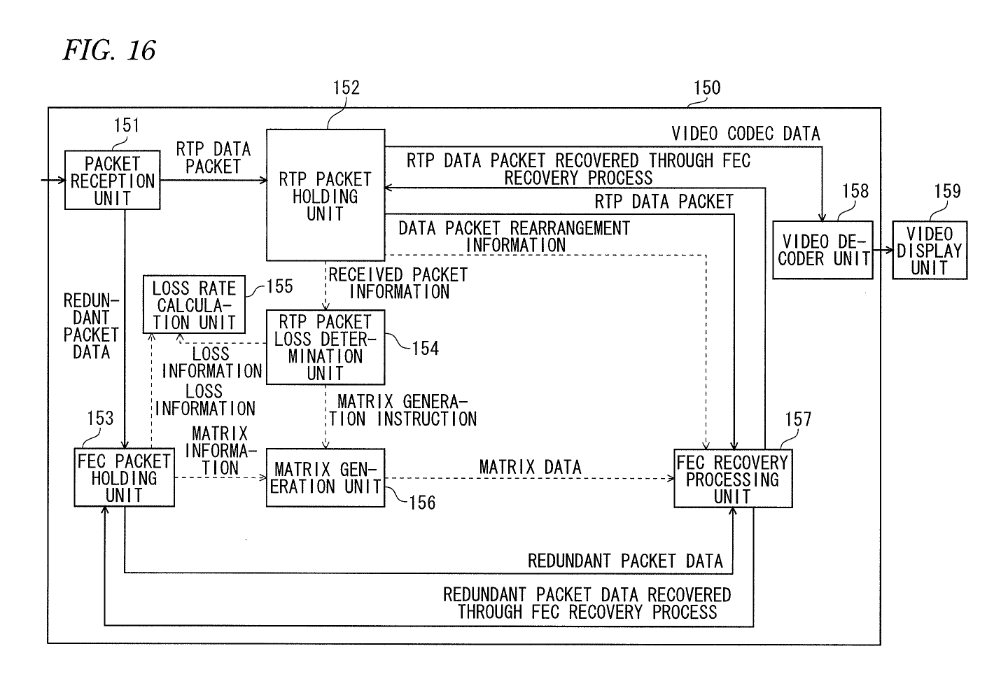

FIG. 16 is a block diagram illustrating a configuration example of the data reception device 150 according to the first embodiment of the present disclosure.

As illustrated in FIG. 16, the data reception device 150 includes a packet reception unit 151, an RTP packet holding unit 152, an FEC packet holding unit 153, an RTP packet loss determination unit 154, a loss rate calculation unit 155, a matrix generation unit 156, an FEC recovery processing unit 157, a video decoder unit 158, and a video display unit 159.

The packet reception unit 151 receives a packet from the communication path, and distributes the received packet to the RTP packet holding unit 152 or the FEC packet holding unit 153. The received packet includes at least one of an RTP data packet and a redundant packet.

In other words, the packet reception unit 151 delivers a received RTP data packet to the RTP packet holding unit 152, and delivers a received redundant packet to the FEC packet holding unit 153. In addition, the delivery of an RTP data packet and a redundant packet may be performed by a pointer operation.

The RTP packet holding unit 152 holds information regarding an RTP data packet. The RTP packet holding unit 152 receives an RTP data packet from the packet reception unit 151. In addition, the RTP packet holding unit 152 obtains video codec data from the RTP data packet and delivers the video codec data to the video decoder unit 158. Further, the RTP packet holding unit 152 delivers the RTP data packet to the FEC recovery processing unit 157. In relation to this delivery, pointer information indicating a location where the data is preserved may be delivered.

In addition, the RTP packet holding unit 152 delivers the data packet rearrangement information added to the RTP header to the FEC recovery processing unit 157. Further, the RTP packet holding unit 152 delivers received packet information including information indicating reception circumstances, that is, whether or not a packet is lost, to the RTP packet loss determination unit 154. Furthermore, the RTP packet holding unit 152 receives a recovered RTP data packet from the FEC recovery processing unit 157.

The video decoder unit 158 receives the video codec data from the RTP packet holding unit 152 so as to perform a decoding process thereon according to a rule of H.264 or the like, and delivers resultant video data to the video display unit 159.

The video display unit 159 displays videos from the video decoder unit 158.

The RTP packet loss determination unit 154 receives the reception information from the RTP packet holding unit 152 and determines whether or not a packet loss occurs. If a packet loss occurs, the matrix generation unit 156 is instructed to generate a matrix. In addition, the RTP packet loss determination unit 154 notifies the loss rate calculation unit 155 of loss information including information indicating whether or not a packet loss occurs.

The loss rate calculation unit 155 receives the loss information from the RTP packet loss determination unit 154, and receives the loss information from the FEC packet holding unit 153. The loss rate calculation unit 155 may calculate a loss rate on the basis of the loss information, and may notify the data transmission device 100 of the loss rate.

The FEC packet holding unit 153 holds information regarding a redundant packet. The FEC packet holding unit 153 receives data of redundant packets from the packet reception unit 151. In addition, the FEC packet holding unit 153 notifies the FEC recovery processing unit 157 of the data of redundant packets. In relation to this notification, a notification of pointer information indicating a position where the data of redundant packets is preserved may be sent.

In addition, the FEC packet holding unit 153 delivers matrix information for generating a matrix added to the header to the matrix generation unit 156. The matrix information includes the total number N of packets, the number k of RTP data packets, and a value of Seed.

In addition, the FEC packet holding unit 153 delivers the loss information of a redundant packet to the loss rate calculation unit 155. Since the number of redundant packets can be estimated from the total number N of packets, the number of redundant packets which are not received, that is, the number of lost packets which fail to be received can be known.

In addition, the FEC packet holding unit 153 receives a redundant packet which is recovered by the FEC recovery processing unit 157. The recovered redundant packet is held, and thus it is possible to recursively perform a recovery process.

The matrix generation unit 156 receives the matrix information from the FEC packet holding unit 153, and generates a matrix on the basis of the matrix information. The matrix generation unit 156 performs a process of generating a matrix when an instruction for generating a matrix is received from the RTP packet loss determination unit 154.

In addition, the matrix generation unit 156 notifies the FEC recovery processing unit 157 of the matrix data. In relation to this notification, a notification of pointer information indicating a position where the matrix data is preserved may be sent.

In addition, the instruction for generating a matrix may be generated each time a packet is received. Further, the same matrix may be shared in advance with the data transmission device 100 and may be held, without using the instruction for generating a matrix. Here, a case where a matrix is generated is mostly assumed.

The FEC recovery processing unit 157 receives the RTP data packet from the RTP packet holding unit 152, and receives the data of redundant packets from the FEC packet holding unit 153. In addition, data packet rearrangement information is received from the RTP packet holding unit 152, and the matrix data is received from the matrix generation unit 156.

The FEC recovery processing unit 157 rearranges data packets on the basis of the data packet rearrangement information. In addition, the FEC recovery processing unit 157 recovers a lost packet on the basis of the received information. The FEC recovery processing unit 157 delivers the packet to the RTP packet holding unit 152 if the recovered packet is an RTP data packet, and delivers the packet to the FEC packet holding unit 153 if the packet is a redundant packet.

Next, details of the packet recovery process will be described.

The FEC recovery processing unit 157 identifies what number of packet unreceived data is from the data packet rearrangement information included in the extension header of the RTP header illustrated in FIG. 14. Since there is a case where a plurality of packets are lost, the FEC recovery processing unit 157 determines whether or not recovery thereof is possible based on the matrix data.

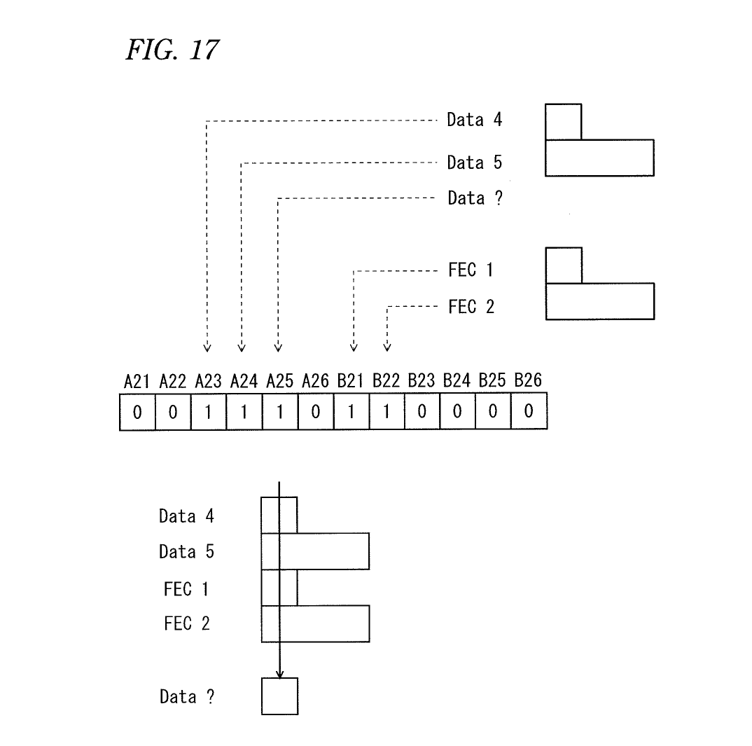

FIG. 17 is a diagram illustrating a specific example of a packet recovery process. In the example of FIG. 17, a case where the data transmission device 100 creates redundant packets after the data packets illustrated in FIG. 11 are rearranged is assumed. In addition, a case where the data reception device 150 receives Data4, Data5, FEC1, and FEC2 in this order as a packet group PS21 is assumed.

The FEC recovery processing unit 157 recognizes that Data4 and Data5 respectively correspond to the third column and the fourth column, from the data packet rearrangement information included in the extension header of the RTP header illustrated in FIG. 14. Similarly, the FEC recovery processing unit 157 also recognizes that a data packet corresponding to the fifth column of the matrix is not received. The data packet corresponding to the fifth column of the matrix has not been recovered yet, and is indicated by “Data?” in FIG. 17.

In addition, the FEC recovery processing unit 157 understands that the redundant packets FEC1 and FEC2 are received on the basis of the FEC header of the redundant packet illustrated in FIG. 15. Specifically, whether or not redundant packets are FEC1 and FEC2 is determined based on “FEC Sequence Number”, “Start sequence number”, and the value of k.

The FEC recovery processing unit 157 calculates a packet length of a data packet corresponding to the fifth column of the matrix on the basis of the value of “Length recovery” included in the FEC header of FEC2, and the values of the packet lengths of Data4, Data5 and FEC1.

Therefore, as illustrated in FIG. 17, the FEC recovery processing unit 157 performs XOR calculation on Data4, Data5, FEC1, and FEC2 in a range of the calculated packet length so as to recover the lost packet (Data?).

Accordingly, it can be seen that the recovered packet is Data6. The recovered RTP data packet is delivered to the RTP packet holding unit 152.

In addition, even in a case where a packet group with packet lengths which are not unified is received, a packet length of a lost packet can be estimated using a value of “Length recovery”. Therefore, it is possible to recover a lost packet while reducing a data calculation amount.

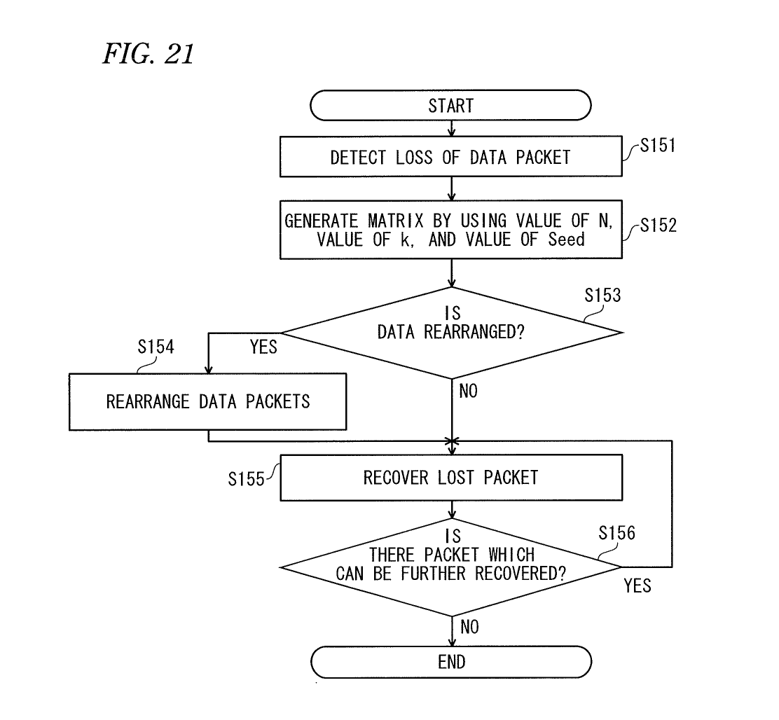

Next, with reference to FIG. 21, a flow of processes performed by the data reception device 150 will be described.

First, the packet reception unit 151 receives a packet. An RTP data packet is held by the RTP packet holding unit 152, and a redundant packet is held by the FEC packet holding unit 153.

The RTP packet loss determination unit 154 receives information regarding the received packet from the RTP packet holding unit 152 and determines whether or not there is a packet loss (step S151). Whether or not there is a loss may be checked using “Sequence Number” illustrated in FIG. 13. In a case where a loss is found, the RTP packet loss determination unit 154 transmits a matrix generation instruction to the matrix generation unit 156, thereby starting a recovery process. In other words, processes in and after step S152 are performed.

The FEC packet holding unit 153 delivers the total number N of packets, the number k of RTP data packets, and a value of Seed included in the matrix information to the matrix generation unit 156. In addition, the matrix generation unit 156 generates a matrix (step S152).

Successively, the FEC recovery processing unit 157 determines whether or not a data packet rearrangement process is performed from the RTP header information (step S153). Whether or not the data packet rearrangement process is performed may be determined based on whether or not data packet rearrangement information is added to the extension header of the RTP header. Although an example of the rearrangement information of the data packet is illustrated in FIG. 14, it is determined whether or not the extension header includes the data packet rearrangement information on the basis of a value of “defined by profile”.

In a case where the data packet rearrangement process is performed, the FEC recovery processing unit 157 performs the data packet rearrangement process (step S154). In addition, the FEC recovery processing unit 157 performs a recovery process on rearranged packets (step S155).

On the other hand, in a case where the data packet rearrangement process is not performed, the FEC recovery processing unit 157 performs a recovery process on the packets which are not rearranged (step S155).

Successively, the FEC recovery processing unit 157 checks whether or not there is a packet which can be further recovered using the recovered packet (step S156). If there is a packet which can be recovered, the FEC recovery processing unit 157 performs a recovery process (step S155).

The recovery process is performed on both a data packet and a redundant packet. This is because there is a case where there is a packet which can be recursively recovered by recovering a recovered packet.

Next, a data reduction effect of redundant packets due to the above-described data packet rearrangement will be verified.

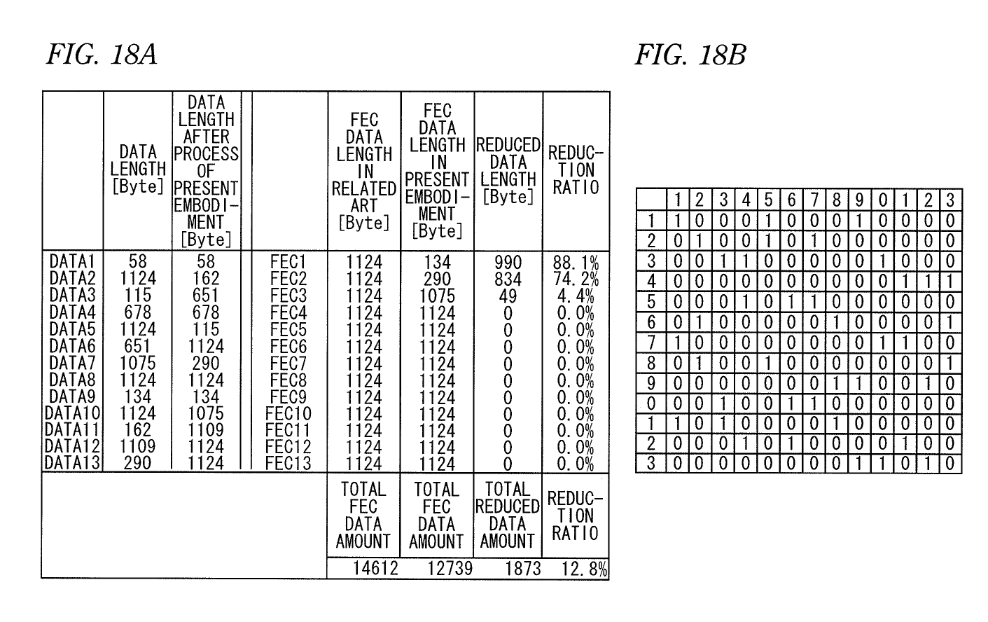

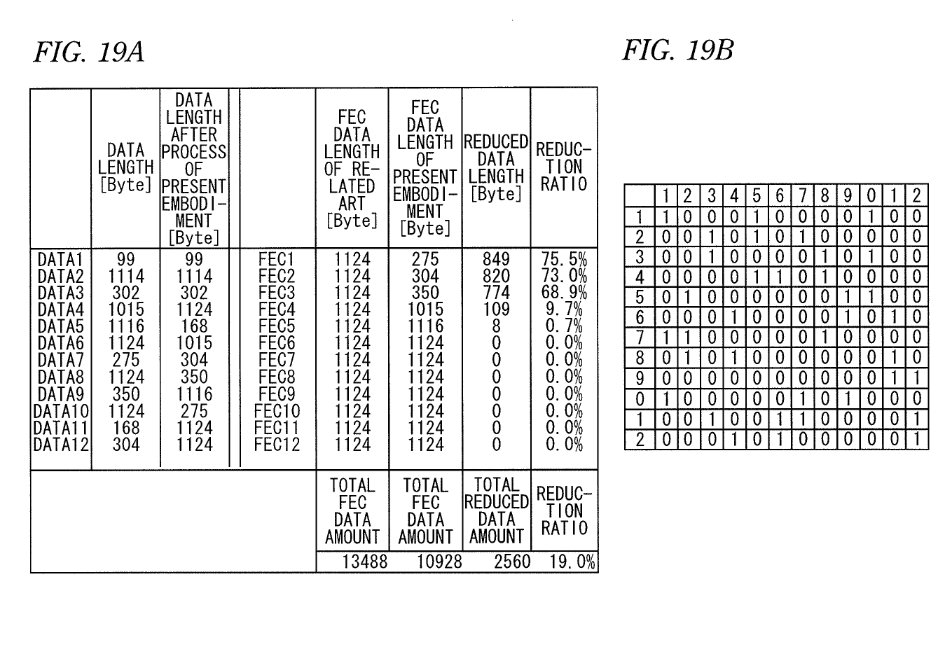

A result regarding to what degree there is a reduction effect is illustrated in FIGS. 18A and 18B and FIGS. 19A and 19B by using actual data when video data is encoded to be divided into packets.

In the example of FIGS. 18A and 18B, a result of processing thirteen data packets (DATA1 to DATA13) is illustrated. FIG. 18A illustrates information regarding data of RTP data packets and redundant packets. FIG. 18B illustrates a matrix for generating data of the redundant packets.

With reference to FIGS. 18A and 18B, as a data reduction ratio in a case where the rearrangement is performed, FEC1 has a reduction ratio of 88%, FEC2 has a reduction ratio of 74%, and FEC3 has a reduction ratio of 4% as compared with a case where the rearrangement is not performed. In addition, when a total data amount of redundant packets is compared, there is a reduction effect of 13%.

In the example of FIGS. 19A and 19B, a result of processing twelve data packets (DATA1 to DATA12) is illustrated. FIG. 19A illustrates information regarding data of RTP data packets and redundant packets. FIG. 19B illustrates a matrix for generating data of the redundant packets.

With reference to FIGS. 19A and 19B, as a data reduction ratio in a case where the rearrangement is performed, FEC1 has a reduction ratio of 76%, FEC2 has a reduction ratio of 73%, FEC3 has a reduction ratio of 69%, FEC4 has a reduction ratio of 10%, and FEC5 has a reduction ratio of 1% as compared with a case where the rearrangement is not performed. In addition, when a total data amount of redundant packets is compared, there is a reduction effect of 19%.

As above, in the data reception device 150, the FEC recovery processing unit 157 recovers an incorrect packet which has not been correctly received by the packet reception unit 151 on the basis of at least one of a rearranged data packet and a redundant packet. The incorrect packet includes both a packet which is lost and thus is not received, and a packet in which an error is determined as occurring through CRC check or the like.

According to the data reception device 150, it is possible to reliably recover a data packet by using at least one of a data packet and a redundant packet of which a data amount is reduced. In addition, since a data amount of redundant packets is reduced, a data calculation amount is reduced when a data packet is recovered, and thus it is possible to reduce a processing load on the communication device.

### Second Embodiment

In the second embodiment, it is assumed that data packet rearrangement information is stored in an FEC header. Description of the same content as in the above-described embodiment will be omitted.

(Transmission Side)

A data transmission device 100B will be described.

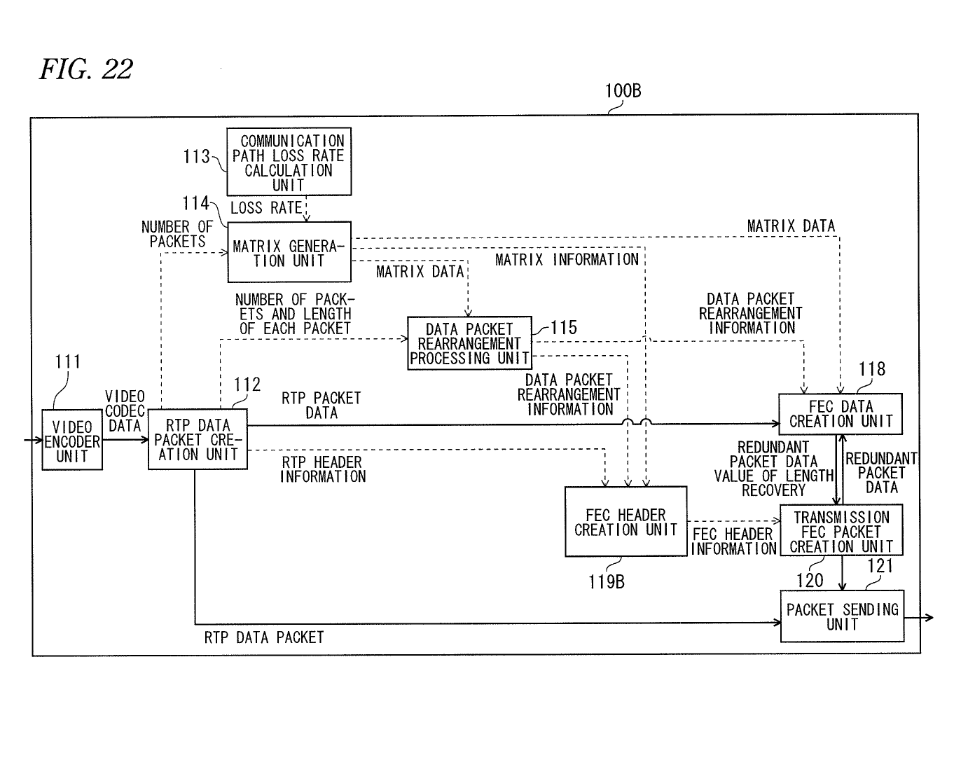

FIG. 22 is a block diagram illustrating a configuration example of the data transmission device 100B according to the second embodiment of the present disclosure. In FIG. 22, a constituent element which has the substantially same function as in the data transmission device 100 of the first embodiment is given and indicated by the same reference number.

As illustrated in FIG. 22, the data transmission device 100B does not include the RTP header correction unit 116 and the transmission RTP packet creation unit 117 illustrated in FIG. 8. In addition, a function of an FEC header creation unit 119B is slightly different from the function of the FEC header creation unit 119 of FIG. 8.

The packet sending unit 121 receives an RTP data packet from the RTP data packet creation unit 112. In addition, the FEC data creation unit 118 receives an RTP data packet from the RTP data packet creation unit 112.

The FEC header creation unit 119B receives matrix information from the matrix generation unit 114, receives RTP header information from the RTP data packet creation unit 112, and receives data packet rearrangement information from the data packet rearrangement processing unit 115. The FEC header creation unit 119B generates an FEC header on the basis of the received information.

The FEC header creation unit 119B adds data packet rearrangement information to the FEC header. In addition, the FEC header creation unit 119B delivers the created FEC header information to the packet sending unit 121. Pointer information may be delivered.

Next, a header will be described.

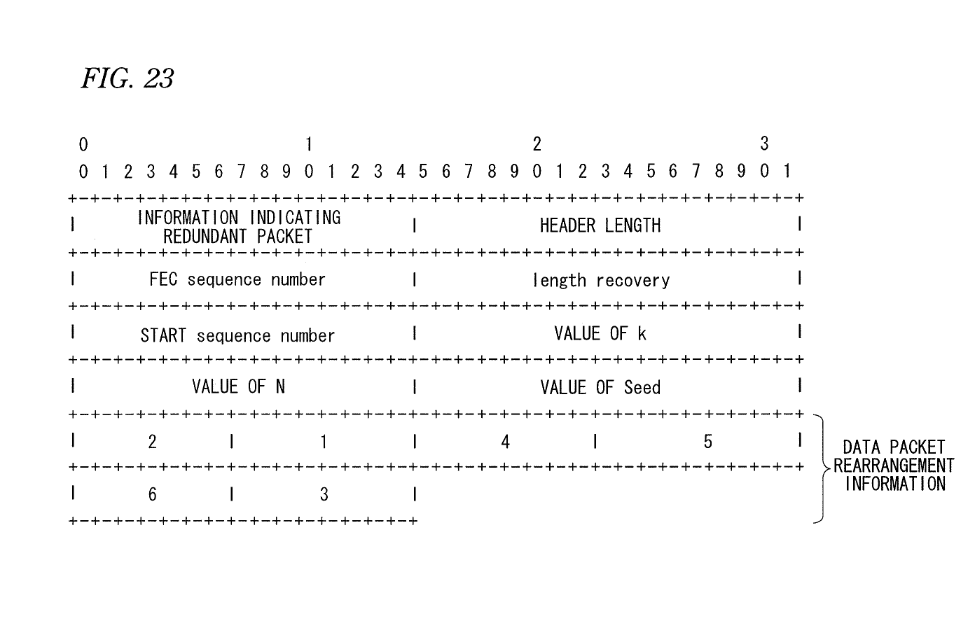

FIG. 23 is a diagram illustrating an example of a header (FEC header) of a redundant packet (FEC packet). A difference from the FEC header of the first embodiment is that data packet rearrangement information is included as additional information in a region following a value of Seed.

A value of “FEC sequence number” is determined not by the FEC header creation unit 119B but by the FEC data creation unit 118, and is added to the FEC header by the transmission FEC packet creation unit 120. In addition, the FEC header creation unit 119 may receive information regarding “FEC Sequence number” from the FEC data creation unit 118, and the FEC header creation unit 119 may add the information to the FEC header.

A value of “Length recovery” is determined not by the FEC header creation unit 119B but by the FEC data creation unit 118, and is added to the FEC header by the transmission FEC packet creation unit 120. In addition, the FEC header creation unit 119 may receive information regarding “Length recovery” from the FEC data creation unit 118, and the FEC header creation unit 119 may add the information to the FEC header.

As “Start sequence number”, a value of k, a value of N, and a value of Seed, the values which are received by the FEC header creation unit 119B are in the header. In addition, an implementation can be performed so that the transmission FEC packet creation unit 120 sets “Start sequence number”. In this case, delivery of RTP header information from the RTP data packet creation unit 112 to the FEC header creation unit 119B may be omitted.

In the example illustrated in FIG. 23, a region holding the data packet rearrangement information is assigned subsequently to the value of Seed of the FEC header. In the example illustrated in FIG. 23, as the data packet rearrangement information, six numbers, “2”, “1”, “4”, “5”, “6”, and “3” are written.

Example of FIG. 23 illustrates content written in the header as a result of the case of rearranging the data packets illustrated in FIG. 9. In other words, the data packet rearrangement information of FIG. 23 indicates that the data packets after being rearranged in FIG. 9 are arranged in order of Data2, Data1, Data4, Data5, Data6, and Data3.

“Start sequence number” included in the FEC header illustrated in FIG. 23 is “Sequence Number” of the first RTP data packet Data1. “Sequence Number” of RTP data packets other than Data1 can be easily calculated by the FEC header creation unit 119B on the basis of “Start sequence number” and the data packet rearrangement information.

In other words, as in FIG. 23, information regarding the numbers, “2”, “1”, “4”, “5”, “6”, and “3”, is added to the FEC header as the data packet rearrangement information. Therefore, the data reception device 150B can correctly understand the original order of arranged data packets.

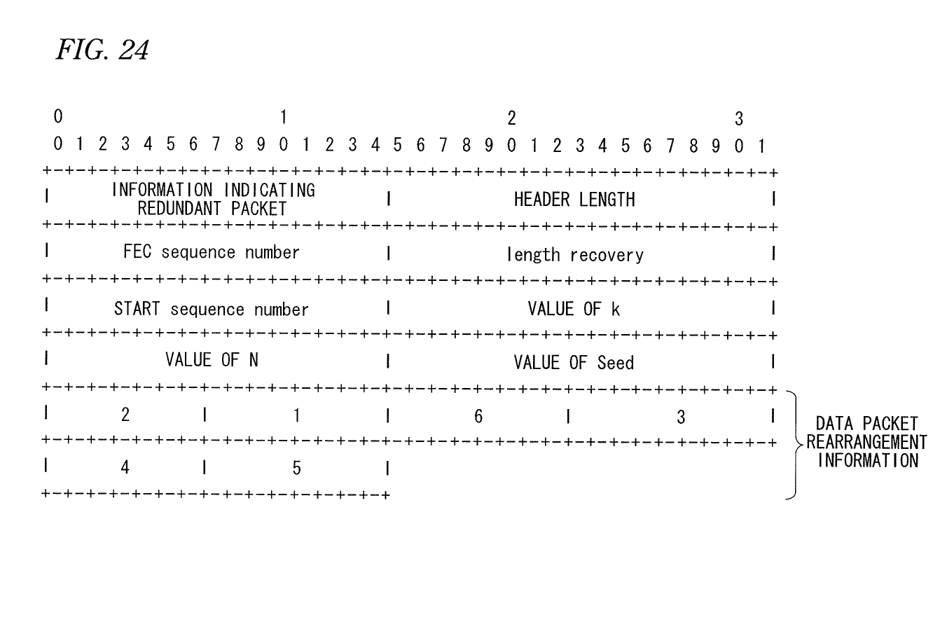

A format of the FEC header may use a format illustrated in FIG. 24 in addition to the example of FIG. 23.

In the example illustrated in FIG. 24, as the data packet rearrangement information, six numbers, “2”, “1”, “6”, “3”, “4”, and “5”, are written. These numbers indicate that respective RTP data packets before being arranged are shifted to what number of data packet due to a rearrangement process. In other words, it is indicated that Data1 is shifted to the second, Data2 is shifted to the first, Data3 is shifted to the sixth, Data4 is shifted to the third, Data5 is shifted to the fourth, and Data6 is shifted to the fifth, after the rearrangement is performed.

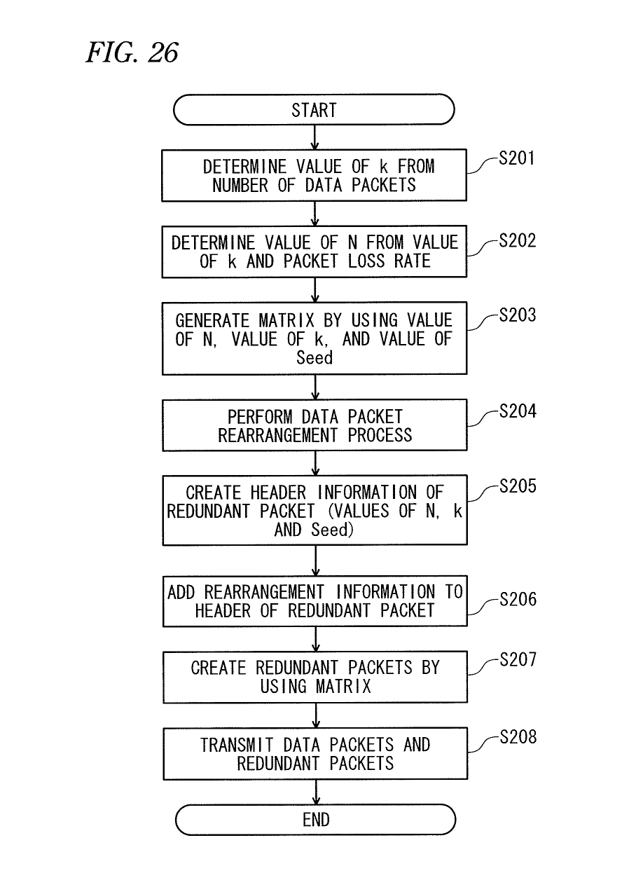

Next, a flow of processes performed by the data transmission device 100B will be described with reference to FIG. 26.

In addition, when the same process as in the description of the above embodiment is performed, description thereof will be omitted or abridged.

First, the RTP data packet creation unit 112 receives video codec data from the video encoder unit 111 so as to create an RTP data packet. The number of RTP data packets is k (step S201).

Subsequently, the matrix generation unit 114 determines the total number N of packets including the number of redundant packets by using a value of the number k of data packets from the RTP data packet creation unit 112 and a loss rate from the communication path loss rate calculation unit 113 (step S202).

Subsequently, the matrix generation unit 114 determines a value of Seed for generating a matrix. The matrix generation unit 114 generates a matrix on the basis of the total number N of packets, the number k of RTP data packets, and Seed (step S203).

Next, the data packet rearrangement processing unit 115 performs a data packet rearrangement process (step S204). The data packet rearrangement processing unit 115 rearranges the order of RTP data packets so that a sum total of data lengths of redundant packets is a small value.

Successively, the FEC header creation unit 119B creates FEC header information on the basis of matrix information from the matrix generation unit 114 and the RTP header information from the RTP data packet creation unit 112 (step S205).

Next, the FEC header creation unit 119B adds data packet rearrangement information received from the data packet rearrangement processing unit 115 to the FEC header (step S206).

Successively, the FEC data creation unit 118 creates a redundant packet on the basis of a matrix generated by the matrix generation unit 114, the RTP data packets created by the RTP data packet creation unit 112, and the data packet rearrangement information created by the data packet rearrangement processing unit 115 (step S207).

In addition, the FEC data creation unit 118 calculates “Length recovery” on the basis of packet length information of a packet used to create the redundant packet. Further, the FEC data creation unit 118 delivers values of “FEC Sequence Number” and “Length recovery” included in the FEC header information to the transmission FEC packet creation unit 120.

In addition, the transmission FEC packet creation unit 120 receives the FEC header information from the FEC header creation unit 119B, and, data of redundant packets, the value of “Length recovery”, and “FEC Sequence Number” from the FEC data creation unit 118. The transmission FEC packet creation unit 120 creates redundant packets to be transmitted, using the received information.

Next, the packet sending unit 121 receives the RTP data packets from the RTP data packet creation unit 112 and receives the redundant packets from the transmission FEC packet creation unit 120. The packet sending unit 121 transmits the RTP data packets and the redundant packets to the data reception device 150B (step S208).

(Reception Side)

The data reception device 150B will be described.

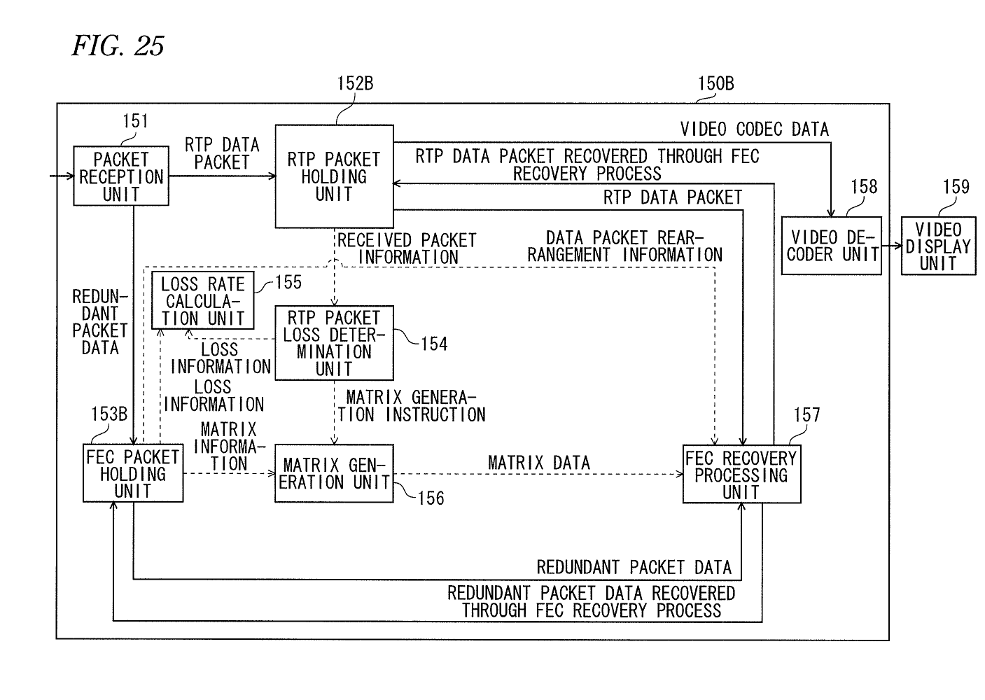

FIG. 25 is a block diagram illustrating a configuration example of the data reception device 150B according to the second embodiment of the present disclosure. In FIG. 25, a constituent element having the substantially same function as in the data reception device 150 of the first embodiment is given and indicated by the same reference number.

As illustrated in FIG. 25, a configuration of the data reception device 150B is substantially the same as the configuration of the data reception device 150 of FIG. 16. However, a function of an RTP packet holding unit 152B and a function of the FEC packet holding unit 153B of FIG. 25 are slightly changed.

The RTP packet holding unit 152B holds information regarding an RTP data packet. An RTP data packet is received from the packet reception unit 151. The RTP packet holding unit 152B obtains video codec data from the RTP data packet, and delivers the data to the video decoder unit 158.

In addition, the RTP packet holding unit 152B delivers the RTP data packet to the FEC recovery processing unit 157. In relation to this delivery, pointer information indicating a position where the data is preserved may be delivered.

Further, the RTP packet holding unit 152B delivers received packet information including information indicating reception circumstances, that is, whether or not a packet is lost, to the RTP packet loss determination unit 154. Furthermore, the RTP packet holding unit 152B receives a recovered RTP data packet from the FEC recovery processing unit 157.

The FEC packet holding unit 153B holds information regarding a redundant packet. The FEC packet holding unit 153B receives data of redundant packets from the packet reception unit 151. In addition, the FEC packet holding unit 153B notifies the FEC recovery processing unit 157 of the data of redundant packets. In relation to this notification, a notification of pointer information indicating a position where the data of redundant packets is preserved may be sent.

In addition, the FEC packet holding unit 153B delivers matrix information for generating a matrix added to the FEC header to the matrix generation unit 156. Further, the FEC packet holding unit 153B delivers the loss information of a redundant packet to the loss rate calculation unit 155. Since the number of redundant packets to be received can be found from the total number N of packets and the number k of data packets, the number of redundant packets which are not received can be known.

In addition, the FEC packet holding unit 153B receives a redundant packet which is recovered by the FEC recovery processing unit 157. The recovered redundant packet is held, and thus it is possible to recursively perform a recovery process.

In addition, the FEC packet holding unit 153B delivers the data packet rearrangement information added to the FEC header to the FEC recovery processing unit 157.

The FEC recovery processing unit 157 receives the RTP data packet from the RTP packet holding unit 152B, and receives the data of redundant packets from the FEC packet holding unit 153B. In addition, the data packet rearrangement information is received from the FEC recovery processing unit 157, and the matrix data is received from the matrix generation unit 114.

In addition, the FEC recovery processing unit 157 recovers a lost packet on the basis of the received information. The FEC recovery processing unit 157 delivers the packet to the RTP packet holding unit 152B if the recovered packet is an RTP data packet, and delivers the packet to the FEC packet holding unit 153B if the packet is a redundant packet.

In the data reception device 150B, other configurations and operations are the same as in the first embodiment.

In addition, a flow of processes in the data reception device 150B is the same as the flow (FIG. 21) of processes in the data reception device 150 of the first embodiment, and thus description thereof will be omitted.

### Third Embodiment

In the third embodiment, it is assumed that data packets are rearranged and a matrix is also rearranged. In addition, it is assumed that data packet rearrangement information is stored in an RTP header, and matrix rearrangement information is stored in an FEC header. Description of the same content as in the first embodiment will be omitted.

(Transmission Side)

A data transmission device 200 will be described.

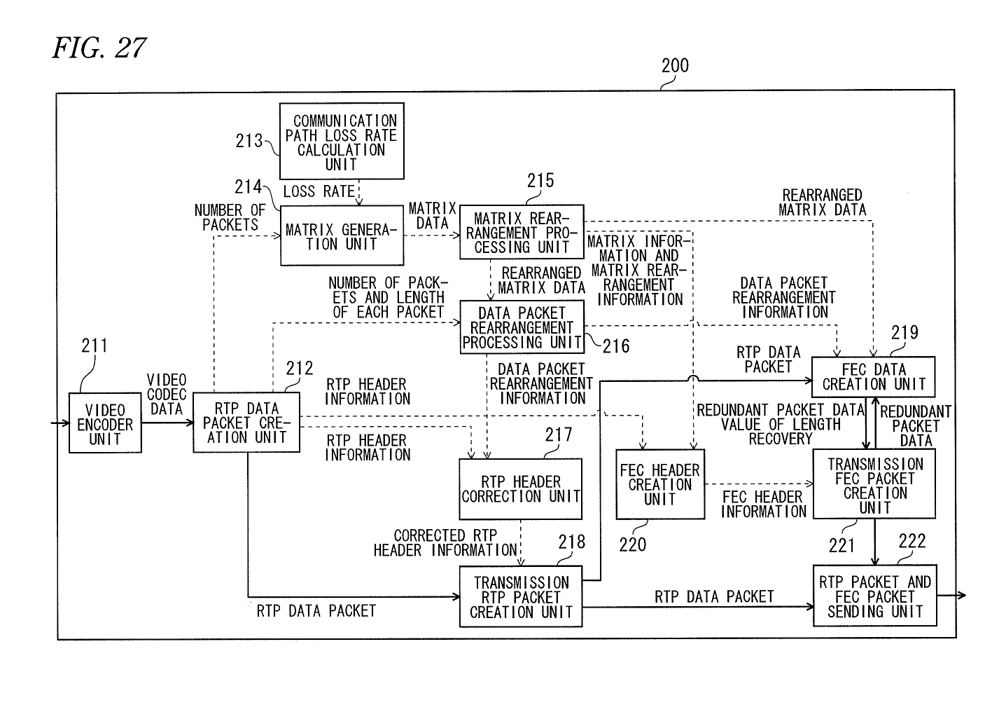

FIG. 27 is a block diagram illustrating a configuration example of the data transmission device 200 according to the third embodiment of the present disclosure.

As illustrated in FIG. 27, the data transmission device 200 includes a video encoder unit 211, an RTP data packet creation unit 212, a communication path loss rate calculation unit 213, a matrix generation unit 214, a matrix rearrangement processing unit 215, a data packet rearrangement processing unit 216, an RTP header correction unit 217, a transmission RTP packet creation unit 218, an FEC header creation unit 219, an FEC header creation unit 220, a transmission FEC packet creation unit 221, and a packet sending unit 222.

The video encoder unit 211 is the same as the video encoder unit 111 of FIG. 8. The RTP data packet creation unit 212 is the same as the RTP data packet creation unit 112 of FIG. 8. The communication path loss rate calculation unit 213 is the same as the communication path loss rate calculation unit 113 of FIG. 8.

The FEC header creation unit 219 is the same as the FEC header creation unit 119 of FIG. 8. The FEC header creation unit 219 is the same as the FEC data creation unit 118 of FIG. 8. The RTP header correction unit 217 is the same as the RTP header correction unit 116 of FIG. 8.

The transmission RTP packet creation unit 218 is the same as the transmission RTP packet creation unit 117 of FIG. 8. The transmission FEC packet creation unit 221 is the same as the transmission FEC packet creation unit 120 of FIG. 8. The packet sending unit 222 is the same as the packet sending unit 121 of FIG. 8.

The matrix generation unit 214 generates a matrix for creating a redundant packet on the basis of a value of the number k of packets from the RTP data packet creation unit 212 and the information regarding the loss rate from the communication path loss rate calculation unit 213. A method of generating a matrix is the same as the method of generating a matrix in the matrix generation unit 114.

The matrix generation unit 214 notifies the matrix rearrangement processing unit 215 of the generated matrix data. In relation to this notification, a notification of pointer information indicating a position where the matrix data is preserved may be sent.

The matrix rearrangement processing unit 215 receives the matrix data from the matrix generation unit 214. The matrix rearrangement processing unit 215 performs a matrix rearrangement process of rearranging rows on the matrix data, and notifies the FEC header creation unit 219 of the rearranged matrix data.

In addition, the matrix rearrangement processing unit 215 notifies the FEC header creation unit 220 of matrix information and rearrangement information of the matrix obtained through the rearrangement process. Further, the matrix rearrangement processing unit 215 notifies the data packet rearrangement processing unit 216 of the rearranged matrix data. In relation to the notification of the matrix data, a notification of pointer information indicating a position where the matrix data is preserved may be sent.

In addition, in FIG. 27, although a case where the matrix generation unit 214 and the matrix rearrangement processing unit 215 are provided as independent constituent elements is assumed, these processing units may be integrally provided.

The data packet rearrangement processing unit 216 receives the rearranged matrix data from the matrix rearrangement processing unit 215, and receives the number k of data packets and information regarding a packet length of each data packet from the RTP data packet creation unit 212.

In addition, the data packet rearrangement processing unit 216 rearranges the order of data packets on the basis of the rearranged matrix data. A data packet rearrangement method is the same as the data packet rearrangement method in the data packet rearrangement processing unit 115.

In addition, a matrix rearrangement process is performed before a data packet rearrangement process is performed. Further, performing a data packet rearrangement process before a matrix rearrangement process is performed is not excluded.

The data packet rearrangement processing unit 216 notifies the FEC header creation unit 219 and the RTP header correction unit 217 of data packet rearrangement information which is a result of performing the data packet rearrangement process.

The FEC header creation unit 219 creates redundant packets on the basis of the rearranged matrix data, the RTP data packets, and the data packet rearrangement information. In addition, there is a case where a redundant packet which has already been created is used to create a redundant packet. In this case, the transmission FEC packet creation unit 221 receives a redundant packet so as to create a new redundant packet.

Further, the FEC data creation unit 219 calculates a value “Length recovery” when creating a redundant packet.

The FEC data creation unit 219 notifies the transmission FEC packet creation unit 221 of data of the created redundant packets, and FEC header information including a value of “Length Recovery” and “FEC Sequence Number”. This notification may be a notification of pointer information indicating a destination where the values are preserved.

The FEC header creation unit 220 receives the matrix information and the matrix rearrangement information from the matrix rearrangement processing unit 215, and receives the RTP header information from the RTP data packet creation unit 212. The FEC header creation unit 220 creates an FEC header on the basis of the received information.

Next, a header will be described.

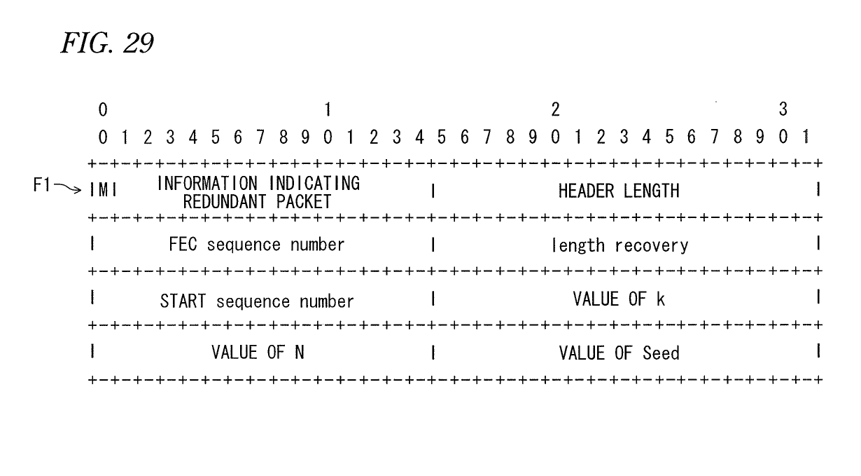

FIG. 29 is a diagram illustrating a specific example of an FEC header of a redundant packet. A difference from the header illustrated in FIG. 15 is that a flag F1 (a bit denoted by “M”) indicating whether or not a matrix rearrangement process is performed is prepared in a most significant bit (MSB). Other parts are the same as the content illustrated in FIG. 15.

In addition, FIG. 29 illustrates only an example, and there is no limitation on a position of an FEC header where information indicating that a matrix rearrangement process has been performed is disposed. Further, the information indicating that a matrix rearrangement process has been performed is not limited to being expressed in one bit. Furthermore, a position where the information indicating that a matrix rearrangement process has been performed is added is not limited to inside of an FEC header.

Next, the matrix rearrangement process in the matrix rearrangement processing unit 215 will be described.

When described briefly, the matrix rearrangement processing unit 215 performs a rearrangement process of rows so as to shift a row capable of reducing a packet length of a redundant packet upward by using the fact that a packet length of a redundant packet can be reduced by a row located on an upper position of a matrix.

Specifically, the matrix rearrangement processing unit 215 shifts a row in which the number of “1” is small to the upper position of the matrix. Next, the matrix rearrangement processing unit 215 treats a column in which an element of an upper row is “1” as a corresponding data packet being already assigned thereto, and extracts only columns to which data packets are not assigned yet. In addition, the matrix rearrangement processing unit 215 selects a row in which the number of “1” is small in elements thereof. The matrix rearrangement processing unit 215 shifts the selected row to an upper position of a row which is not shifted yet in the matrix.

When it is regarded that assignment of data packets to all the columns is completed, the matrix rearrangement process is completed. The matrix rearrangement processing unit 215 performs the matrix rearrangement process on each element (Axy) of the matrix of the group A. No process is performed on each element (Bxy) of the matrix of the group B.

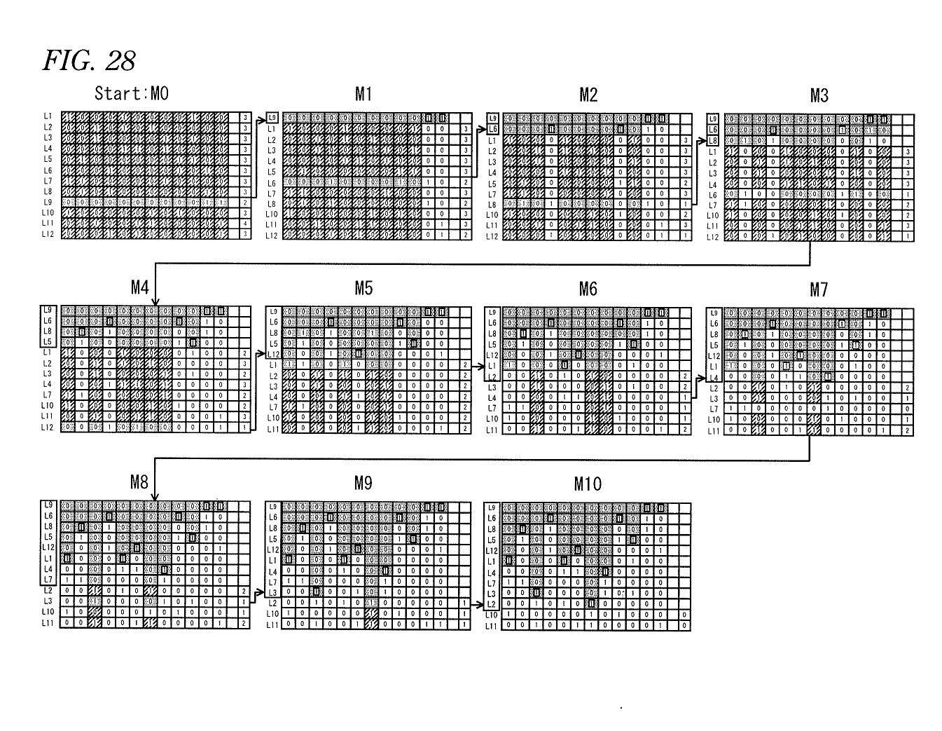

With reference to FIG. 28, content of the matrix rearrangement process will be described. FIG. 28 illustrates changes in states of a matrix due to the matrix rearrangement process.

An initial state “M0” of FIG. 28 corresponds to the matrix of FIG. 19B. In each state of FIG. 28, the number of “1” included in each row of the matrix is illustrated on the right side of each row. In addition, a row number before the matrix rearrangement process is performed at each timing is illustrated on the left side of the matrix. A row in which the number of “1” is the minimum is the ninth row (L9), and thus L9 is shifted to the top position of the matrix. A state after the shift is indicated by “M1”.

In the “M1” state, the eleventh column and the twelfth column of L9 shifted to the top position are “1”, and thus the number of “1” included in the other columns (the first column to the tenth column) is checked. The number of “1” of each row when “1” included in the eleventh column and twelfth column is excluded is illustrated on the right side of the matrix. In the “M1” state, rows in which the number of “1” is two are L6, L8, and L12. Among the rows, L6 located at the uppermost position is shifted to an upper position of the rows which are not shifted. In other words, L6 is shifted to the second row. A state after L6 is shifted is indicated by “M2”.

In the “M2” state, columns with “1” in L6 are the fourth column and the ninth column. The number of “1” of each row when “1” included in the fourth column and ninth column is also excluded is illustrated on the right side of the matrix. In the “M2” state, the number of “1” of L8 and L12 is one, and thus L8 located at the upper position is shifted. A state after the shift is “M3”.

When the above-described process is sequentially repeatedly performed, the rearrangement of the rows is completed in order of L9, L6, L8, L5, L12, L1, L4, L7, L3, L2, L10 and L11 in an “M10” state.

In addition, the above-described method of rearranging rows of a matrix is only an example, and other methods may be used. The same process is preferably performed in the data transmission device 200 side and a data reception device 250 side.

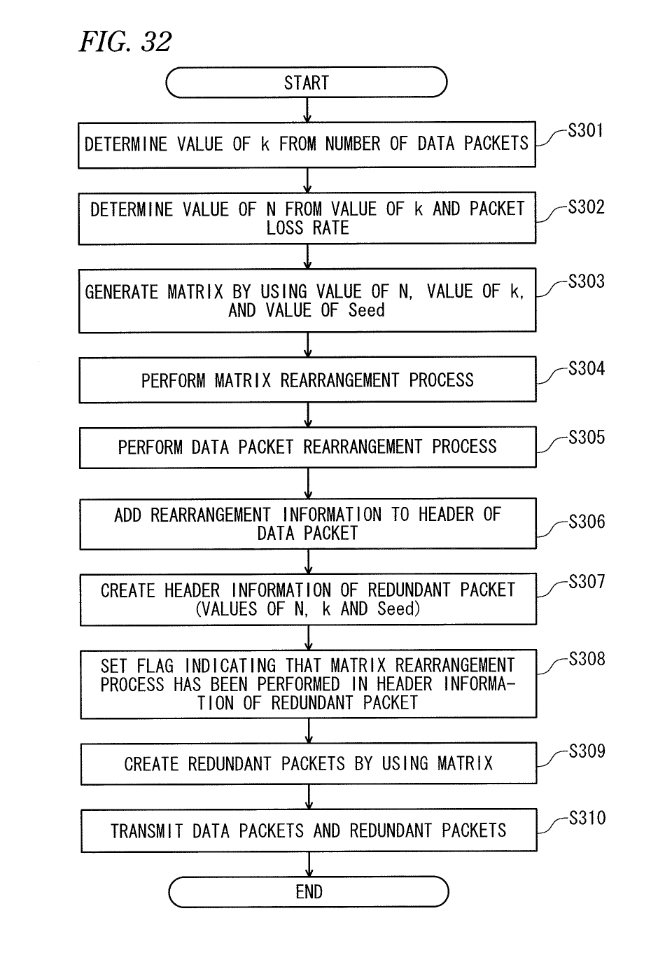

Next, with reference to FIG. 32, a flow of processes performed by the data transmission device 200 will be described.

In addition, when the same process as in the description of the above embodiment is performed, description thereof will be omitted or abridged.

First, the RTP data packet creation unit 212 receives video codec data from the video encoder unit 211 so as to create an RTP data packet. The number of RTP data packets is determined as k (step S301).

Subsequently, the matrix generation unit 214 determines the total number N of packets including the number of redundant packets by using a value of the number k of data packets from the RTP data packet creation unit 212 and a loss rate from the communication path loss rate calculation unit 213 (step S302).

Subsequently, the matrix generation unit 214 determines a value of Seed for generating a matrix. The matrix generation unit 214 generates a matrix on the basis of the total number N of packets, the number k of data packets, and the value of Seed (step S303).

Next, the matrix rearrangement processing unit 215 performs a matrix rearrangement process (step S304).

Successively, the data packet rearrangement processing unit 216 performs a data packet rearrangement process (step S305).

Next, the RTP header correction unit 217 adds data packet rearrangement information to an extension header of an RTP header on the basis of the data packet rearrangement information received from the data packet rearrangement processing unit 216 (step S306). A format of the RTP header to which the data packet rearrangement information is added may use the example illustrated in FIG. 14. The transmission RTP packet creation unit 218 creates RTP data packets to be transmitted, using the corrected RTP header and the RTP data packets.

Successively, the FEC header creation unit 220 creates FEC header information on the basis of matrix information and matrix rearrangement information from the matrix rearrangement processing unit 215 and the RTP header information from the RTP data packet creation unit 212 (step S307).

Next, the FEC header creation unit 220 sets information indicating that the matrix rearrangement process has been performed in the FEC header information (step S308). Specifically, an “M”-bit flag F1 in the header format of FIG. 29 is set.

Next, the FEC header creation unit 219 creates a redundant packet (step S309).

In addition, the FEC header creation unit 219 calculates “Length recovery” on the basis of packet length information of a packet used to create the redundant packet.

Further, the FEC data creation unit 219 delivers values of “FEC Sequence Number” and “Length recovery” included in the FEC header information to the transmission FEC packet creation unit 221.

The transmission FEC packet creation unit 221 receives the FEC header information from the FEC header creation unit 220. In addition, the transmission FEC packet creation unit 221 receives data of redundant packets, the value of “Length recovery”, and the value of “FEC Sequence Number” from the FEC data creation unit 219. The transmission FEC packet creation unit 221 creates redundant packets to be transmitted by using the received information.

Successively, the packet sending unit 222 receives the RTP data packets from the transmission RTP packet creation unit 218, and receives the redundant packets from the transmission FEC packet creation unit 221. The packet sending unit 222 transmits the RTP data packets and the FEC packets to the data reception device 250 (step S310).

Next, detailed procedures of the matrix rearrangement process will be described.

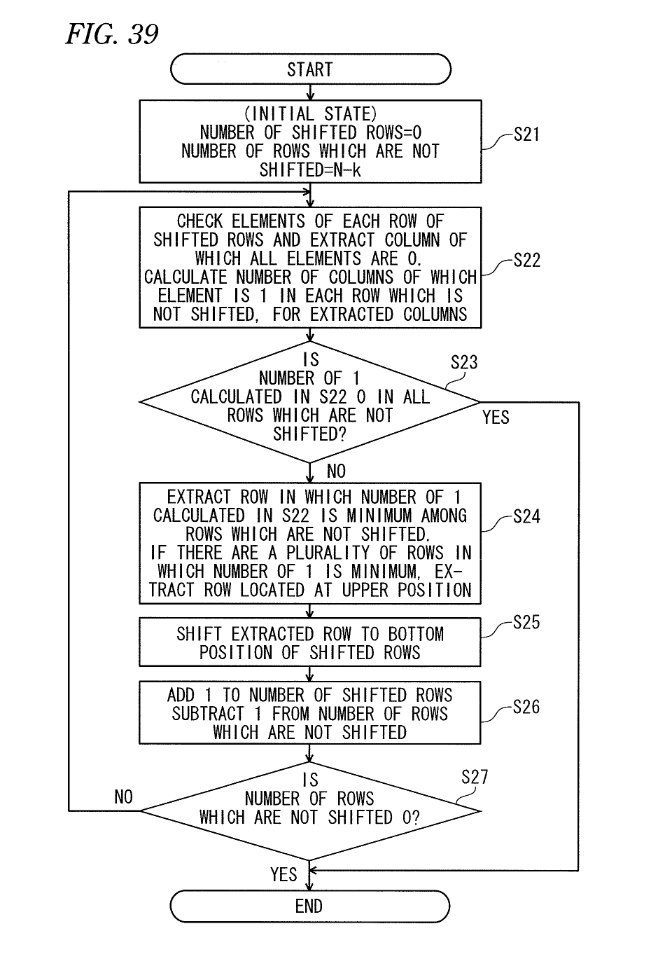

FIG. 39 is a diagram illustrating procedures of the matrix rearrangement process in the matrix rearrangement processing unit 215. In other words, FIG. 39 illustrates details of the process in step S304 of FIG. 32.

First, the matrix rearrangement processing unit 215 initializes variables used during the matrix rearrangement process. Specifically, a variable of “the number of shifted rows” is initialized to 0, and a variable of “the number of rows which are not shifted” is initialized to a state of “N−k” (step S21).

Next, the matrix rearrangement processing unit 215 checks elements of each row of shifted rows of the matrix and extracts a column of which all the elements are “0”. In addition, the matrix rearrangement processing unit 215 calculates the number of columns of which the element is “1” in each row which is not shifted, for the extracted columns (step S22).

Successively, the matrix rearrangement processing unit 215 identifies whether or not the number of calculated “1” is 0 in all rows which are not shifted (step S23).

In a case where the number thereof is not 0 in all the rows which are not shifted, the matrix rearrangement processing unit 215 extracts a row in which the number of calculated “1” is the minimum among the rows which are not shifted in the matrix. If there are a plurality of rows in which the number of “1” is the minimum, a row located at an upper position is extracted.

Next, the matrix rearrangement processing unit 215 shifts the extracted row to a bottom position of the shifted rows.

Next, the matrix rearrangement processing unit 215 adds 1 to a value of “the number of shifted rows”, and subtracts 1 from a value of “the number of rows which are not shifted” (step S26).

Next, the matrix rearrangement processing unit 215 refers to the variable of “the number of rows which are not shifted” so as to identify whether or not the number of rows which are not shifted is 0 (step S27). If “the number of rows which are not shifted” is not 0, the flow returns to step S22, and if “the number of rows which are not shifted” is 0, the process finishes.

As above, in the data transmission device 200, when data packets are assigned to respective columns of matrix data, the matrix rearrangement processing unit 215 rearranges rows of the matrix data so that, as a row of the matrix data is located at a further upper position, the number of data packets to be assigned is reduced.

According to the data transmission device 200, rows of a matrix are rearranged in a desired order, and thus it is possible to further reduce a data amount of redundant packets to be generated.

(Reception Side)

The data reception device 250 will be described.

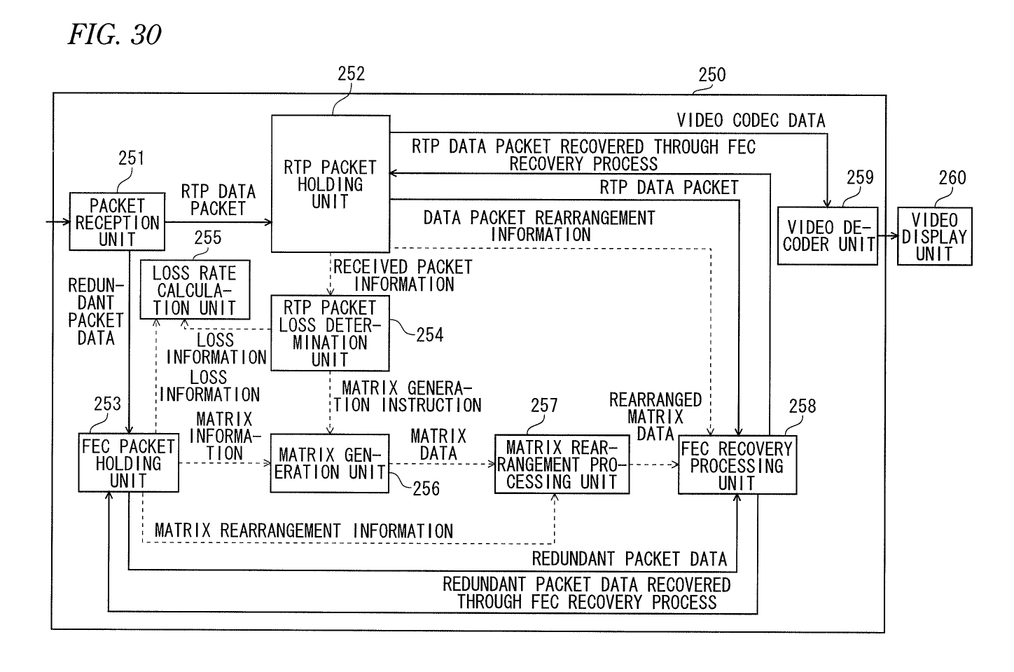

FIG. 30 is a block diagram illustrating a configuration example of the data reception device 250 according to the third embodiment of the present disclosure.

As illustrated in FIG. 30, the data reception device 250 includes a packet reception unit 251, an RTP packet holding unit 252, an FEC packet holding unit 253, an RTP packet loss determination unit 254, a loss rate calculation unit 255, a matrix generation unit 256, a matrix rearrangement processing unit 257, an FEC recovery processing unit 258, a video decoder unit 259, and a video display unit 260.

The packet reception unit 251 is the same as the packet reception unit 151 of FIG. 16. The RTP packet holding unit 252 is the same as the RTP packet holding unit 152 of FIG. 16. The RTP packet loss determination unit 254 is the same as the RTP packet loss determination unit 154 of FIG. 16. The loss rate calculation unit 255 is the same as the loss rate calculation unit 155 of FIG. 16. The video decoder unit 259 is the same as the video decoder unit 158 of FIG. 16.

The FEC packet holding unit 253 receives data of redundant packets from the packet reception unit 251. In addition, the FEC packet holding unit 253 notifies the FEC recovery processing unit 258 of the data of redundant packets. In relation to this notification, a notification of pointer information indicating a position where the data of redundant packets is preserved may be sent.

In addition, the FEC packet holding unit 253 delivers matrix information included in an FEC header to the matrix generation unit 256. Further, the FEC packet holding unit 253 delivers loss information of redundant packets to the loss rate calculation unit 255. Since the number of redundant packets can be estimated from the total number N of packets, the number of redundant packets which are not received can be known.

In addition, the FEC packet holding unit 253 receives a redundant packet which is recovered by the FEC recovery processing unit 258. The recovered redundant packet is held, and thus it is possible to recursively perform a recovery process.

In addition, the FEC packet holding unit 253 notifies the matrix rearrangement processing unit 257 of matrix rearrangement information. Further, the matrix generation unit 256 and the matrix rearrangement processing unit 257 may be integrated into a single processing unit. In this case, matrix rearrangement information may be included in matrix information delivered to the matrix generation unit 256.

In addition, in the example of an FEC header format illustrated in FIG. 29, 1-bit information (the flag F1) is used which indicates whether or not a matrix rearrangement process is performed. In addition, a result of the matrix rearrangement process may be stored in the FEC header instead of the 1-bit information. In other words, series information may be used which indicates order of rows after the rows are rearranged. Further, procedure information may be used which indicates a row rearrangement procedure. Furthermore, index information may be used which is not row rearrangement procedure information and indicates what kind of procedure.

The matrix generation unit 256 receives the matrix information from the FEC packet holding unit 253, and generates a matrix on the basis of the matrix information. The matrix generation unit 256 performs a process of generating a matrix when an instruction for generating a matrix is received from the RTP packet loss determination unit 254.

The matrix generation unit 256 notifies the matrix rearrangement processing unit 257 of the generated matrix data. In relation to this notification, a notification of pointer information indicating a position where the matrix data is preserved may be sent.

The matrix rearrangement processing unit 257 receives the matrix data from the matrix generation unit 256, and receives the matrix rearrangement information from the FEC packet holding unit 253. The matrix rearrangement processing unit 257 performs a matrix rearrangement process of rearranging rows of the matrix in a case where performing the matrix rearrangement process is shown in the FEC header, that is, the flag F1 is included in the FEC header.

In addition, the matrix rearrangement processing unit 257 delivers the rearranged data to the FEC recovery processing unit 258. In relation to this delivery, pointer information indicating a position where the matrix data is preserved may be delivered.

An algorithm for the matrix rearrangement process performed by the matrix rearrangement processing unit 257 may include the same process as the process (the content of FIG. 39) performed by the matrix rearrangement processing unit 215 of the data transmission device 200.

The FEC recovery processing unit 258 receives RTP data packets from the RTP packet holding unit 252, and receives data of redundant packets from the FEC packet holding unit 253. In addition, the FEC recovery processing unit 258 receives data packet rearrangement information from the RTP packet holding unit 252, and receives the rearranged matrix data from the matrix rearrangement processing unit 257.

The FEC recovery processing unit 258 rearranges data packets on the basis of the data packet rearrangement information. In addition, the FEC recovery processing unit 258 recovers a lost packet on the basis of the received information. The FEC recovery processing unit 258 delivers the packet to the RTP packet holding unit 252 if the recovered packet is an RTP data packet, and delivers the packet to the FEC packet holding unit 253 if the packet is a redundant packet.

The FEC recovery process by the FEC recovery processing unit 258 may be the same as the FEC recovery process by the FEC recovery processing unit 157.

In addition, the matrix rearrangement process is performed before the data packet rearrangement process is performed.

In addition, in a case where the matrix generation unit 256 and the matrix rearrangement processing unit 257 are integrated into a single processing unit, the FEC recovery processing unit 258 may receive the rearranged matrix data from the matrix generation unit 256.

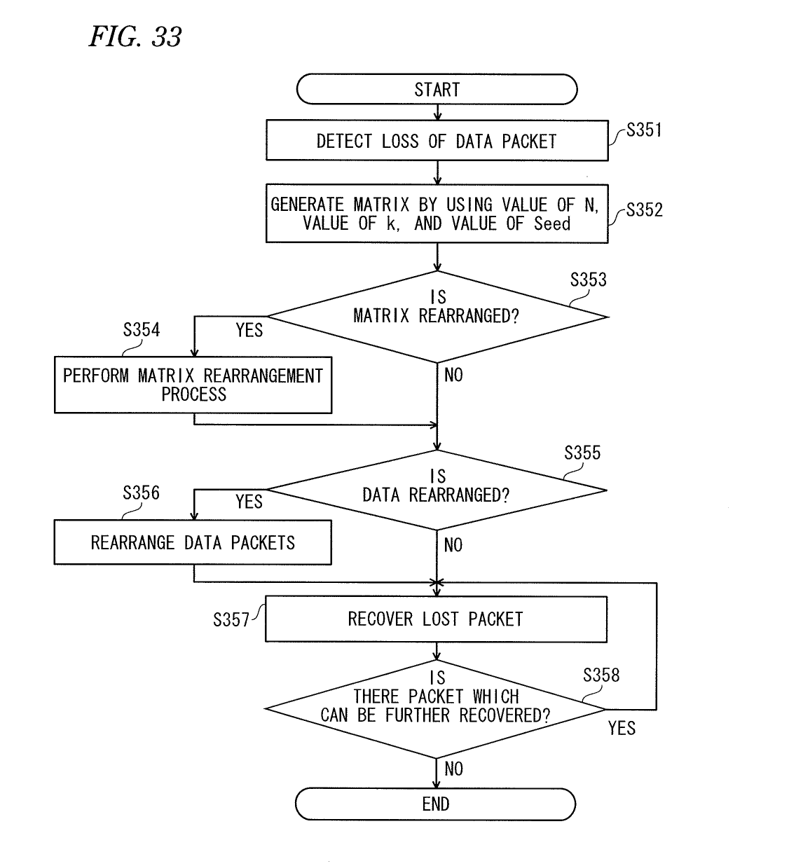

Next, a flow of processes performed by the data reception device 250 will be described with reference to FIG. 33. In addition, when the same process as in the description of the above embodiment is performed, description thereof will be omitted or abridged.

First, the packet reception unit 251 receives a packet, and the RTP packet holding unit 252 preserves the RTP data packet. The RTP packet loss determination unit 254 receives information regarding the received packet from the RTP packet holding unit 252 and determines whether or not there is a packet loss of the RTP data packet on the basis of the received packet information (step S351). In a case where a loss is found, the RTP packet loss determination unit 254 transmits a matrix generation instruction to the matrix generation unit 256, thereby starting a recovery process. In other words, processes in and after step S352 performed.

First, the FEC packet holding unit 253 delivers the total number N of packets, the number k of data packets, and a value of Seed included in the matrix information to the matrix generation unit 256. In addition, the matrix generation unit 214 generates a matrix (step S352).

Next, the FEC packet holding unit 253 identifies whether or not a matrix rearrangement process will be performed from the information (for example, the flag F1 of FIG. 29) included in the FEC header (step S353).

In a case where the matrix rearrangement process will be performed, the matrix rearrangement processing unit 257 performs the matrix rearrangement process (step S354). In a case where the matrix rearrangement process will not be performed, the matrix is left as it is.

Next, the FEC recovery processing unit 258 determines whether or not the data packets have been rearranged from the RTP header information (step S355).

Successively, the FEC recovery processing unit 258 performs a data packet rearrangement process in a case where the data packet rearrangement process has been performed (step S356). In addition, the FEC recovery processing unit 258 performs a recovery process on the rearranged data packets (step S357).

On the other hand, in a case where the data packet rearrangement is not performed, the FEC recovery processing unit 258 performs a recovery process on the packets which are not rearranged (step S357).

Next, the FEC recovery processing unit 258 checks whether or not there is a packet which can be further recovered using the recovered packets (step S358), and performs a recovery process if there is a packet which can be recovered (step S357).

The recovery process is performed on both a data packet and a redundant packet. This is because there is a case where there is a packet which can be recursively recovered by recovering a recovered packet.

Next, a data reduction effect of redundant packets due to the above-described data packet rearrangement and the matrix rearrangement process will be verified.

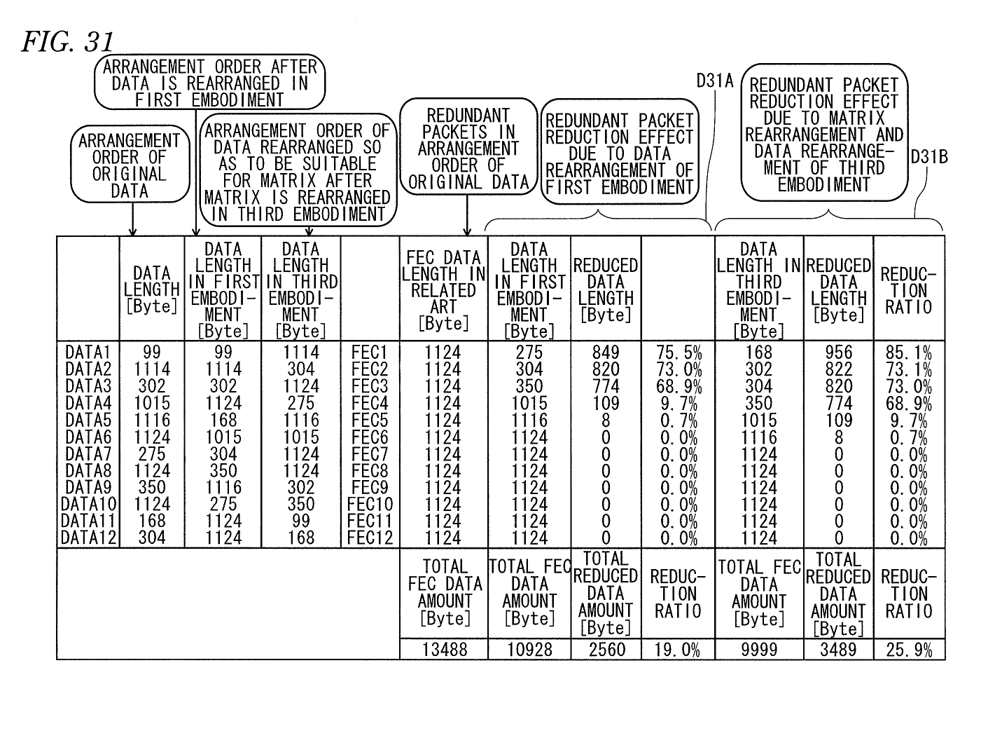

A result indicating to what degree there is a reduction effect is illustrated in FIG. 31 by using actual data when video data is encoded to be divided into packets. In the example of FIG. 31, a result of processing twelve data packets (DATA1 to DATA12: this is the same as the data illustrated in FIGS. 19A and 19B) is illustrated. Content of the matrix rearrangement process and a rearranged matrix in this simulation are the same as in the matrix illustrated in FIG. 28.

In FIG. 31, a result D31A of performing the data packet rearrangement process and a result D31 B of performing the matrix rearrangement process are illustrated so as to be differentiated from each other.

The result D31A of FIG. 31 shows a data reduction ratio when the data packet rearrangement process is performed. In other words, a reduction effect is shown.

Here, a reduction ratio is as follows. FEC1: 76%, FEC2: 73%, FEC3: 69%, FEC4: 10%, and FEC5: 1%. In addition, when a total data amount of redundant packets is compared, it can be seen that there is a reduction effect of 19%.

On the other hand, the result D31B of FIG. 31 shows a data reduction ratio of a case where the data packet rearrangement process is performed after the matrix rearrangement process is performed to a case where neither of the data packet rearrangement process or the matrix rearrangement process is performed. In other words, a reduction effect is shown.

Here, a reduction ratio is as follows. FEC1: 85%, FEC2: 73%, FEC3: 73%, FEC4: 10%, and FEC5: 1%. In addition, when a total data amount of redundant packets is compared, it can be seen that there is a reduction effect of 26%.

In other words, if redundant packets are created after the data packet rearrangement process is performed as in the first embodiment, it is possible to reduce a data amount of the redundant packets. In addition, if redundant packets are created after the matrix rearrangement process and the data packet rearrangement process are performed as in the third embodiment, it is possible to further reduce a data amount of the redundant packets.

As above, in the data reception device 250, the FEC recovery processing unit 258 recovers an incorrect packet on the basis of at least one of a rearranged data packet and a redundant packet, and rearranged matrix data.

According to the data reception device 250, it is possible to rearrange data packets and a matrix in the same order as a desired order which is rearranged by the data transmission device 200 side. Therefore, it is possible to further reduce a data amount when a lost packet is recovered.

### Fourth Embodiment

In the fourth embodiment, it is assumed that data packets are rearranged and a matrix is also rearranged. In addition, it is assumed that data packet rearrangement information and matrix rearrangement information are stored in an FEC header together. Description of the same content as in the first embodiment to the third embodiment will be omitted.

(Transmission Side)

A data transmission device will be described.

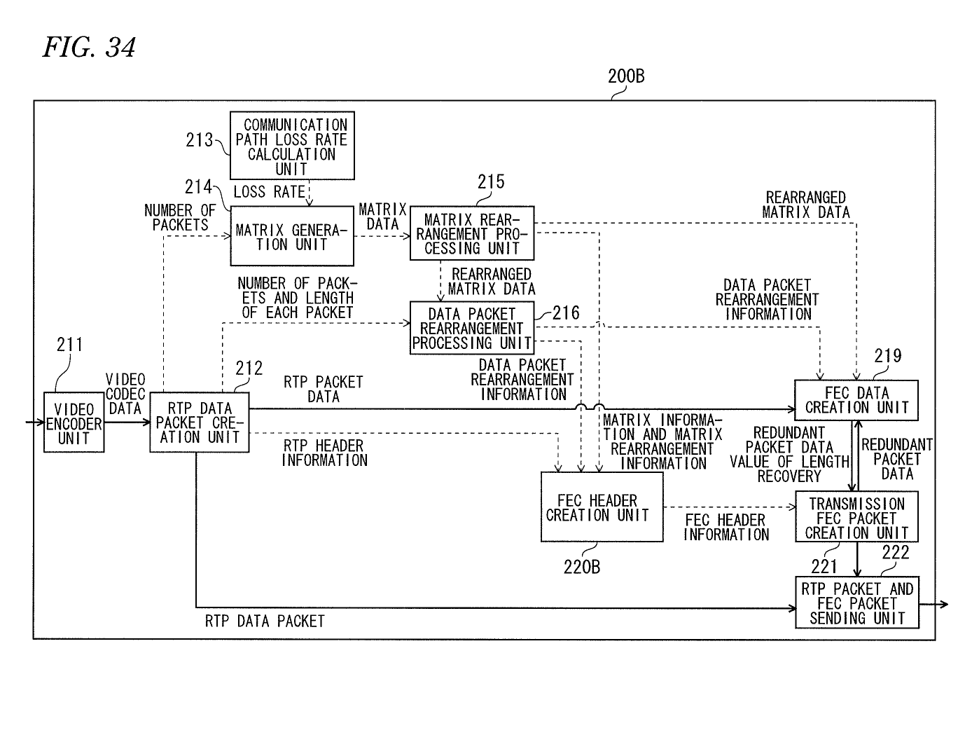

FIG. 34 is a block diagram illustrating a configuration example of a data transmission device 200B according to the fourth embodiment of the present disclosure. In FIG. 34, a constituent element which has the substantially same function as in the data transmission device 200 of the third embodiment is given and indicated by the same reference number.

As illustrated in FIG. 34, the data transmission device 200B does not include the RTP header correction unit 217 and the transmission RTP packet creation unit 218 illustrated in FIG. 27. In addition, a function of an FEC header creation unit 220B is slightly different from the function of the FEC header creation unit 220 illustrated in FIG. 27.

The packet sending unit 222 receives an RTP data packet from the RTP data packet creation unit 212. In addition, the FEC data creation unit 219 receives an RTP data packet from the RTP data packet creation unit 212.

The FEC header creation unit 220B receives the matrix information and the matrix rearrangement information from the matrix rearrangement processing unit 215, and receives the RTP header information from the RTP data packet creation unit 212. In addition, the FEC header creation unit 220B receives data packet rearrangement information from the data packet rearrangement processing unit 216. The FEC header creation unit 220B creates an FEC header on the basis of the received information.

The FEC header creation unit 220B delivers the created FEC header information to the transmission FEC packet creation unit 221. In relation to this delivery, pointer information indicating a position where the FEC header information is present may be delivered.

Next, a header will be described.

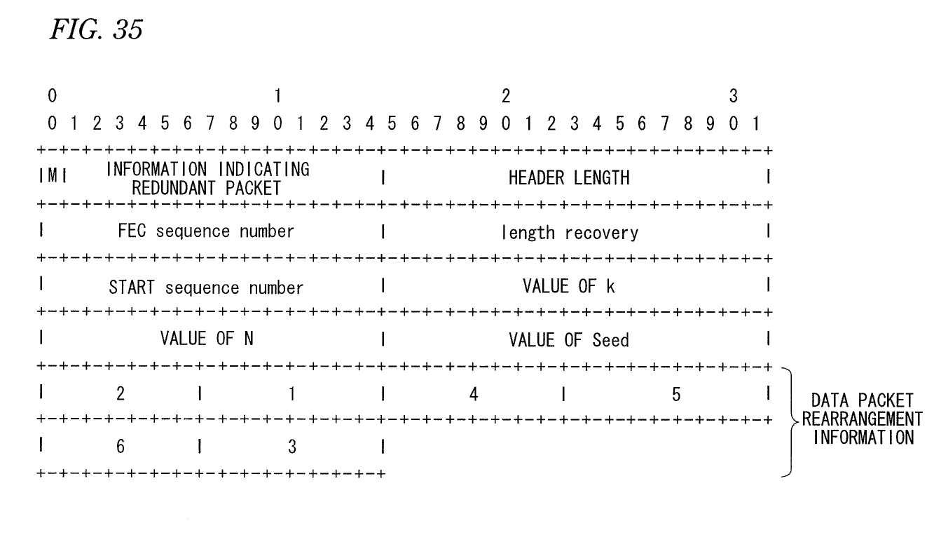

FIG. 35 is a diagram illustrating an example of the FEC header.

The FEC header illustrated in FIG. 35 includes a region storing the flag F1 indicating whether or not matrix rearrangement is performed in the same manner as in the example of FIG. 29. In addition, the FEC header illustrated in FIG. 35 includes a region storing data packet rearrangement information. The data packet rearrangement information stored in the FEC header illustrated in FIG. 35 is the same as the data packet rearrangement information stored in the FEC header described in the second embodiment.

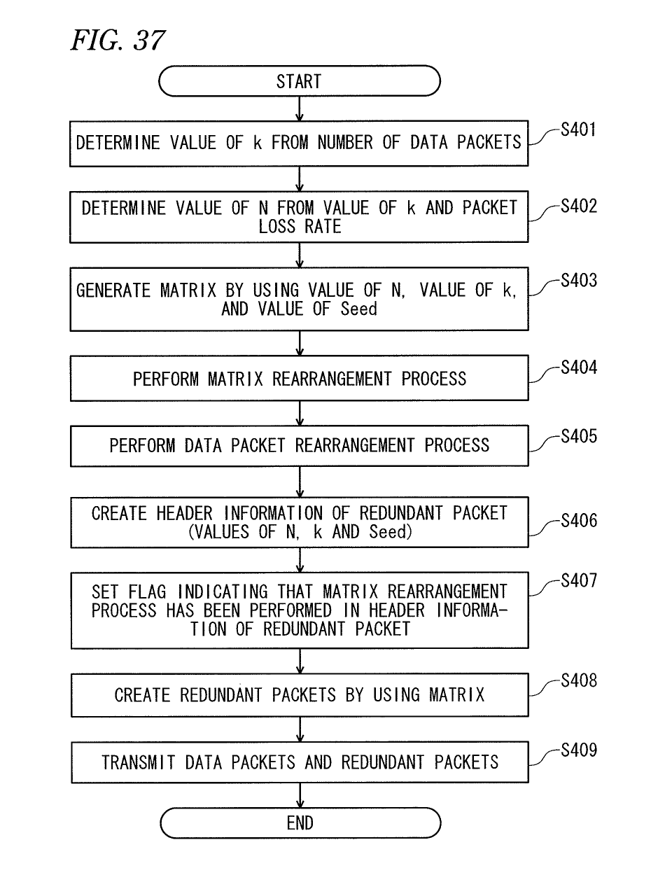

Next, with reference to FIG. 37, a flow of processes performed by the data transmission device 200B will be described.

In addition, when the same process as in the description of the above embodiment is performed, description thereof will be omitted or abridged.

First, the RTP data packet creation unit 212 receives video codec data from the video encoder unit 211 so as to create an RTP data packet. The number of RTP data packets is determined as k (step S401).

Subsequently, the matrix generation unit 214 determines the total number N of packets including the number of redundant packets by using a value of the number k of data packets from the RTP data packet creation unit 212 and a loss rate from the communication path loss rate calculation unit 213 (step S402).

Subsequently, the matrix generation unit 214 determines a value of Seed for generating a matrix. The matrix generation unit 214 generates a matrix on the basis of the value of the total number N of packets, the number k of data packets, and the value of Seed (step S403).

Next, the matrix rearrangement processing unit 215 performs a matrix rearrangement process (step S404).

Successively, the data packet rearrangement processing unit 216 performs a data packet rearrangement process (step S405).

Next, the FEC header creation unit 220B creates FEC header information (step S406).

Next, the FEC header creation unit 220B sets information indicating that the matrix rearrangement process has been performed in the FEC header information (step S407). Specifically, a flag F1 (M bits) in the header format of FIG. 35 is set.

Next, the FEC header creation unit 219 creates a redundant packet (step S408).

In addition, the FEC header creation unit 219 calculates “Length recovery” on the basis of packet length information of a packet used to create the redundant packet. Further, the FEC data creation unit 219 delivers values of “FEC Sequence Number” and “Length recovery” included in the FEC header information to the transmission FEC packet creation unit 221.

The transmission FEC packet creation unit 221 receives the FEC header information from the FEC header creation unit 220B, and receives data of redundant packets, the value of “Length recovery”, and “FEC Sequence Number” from the FEC data creation unit 219. The transmission FEC packet creation unit 221 creates redundant packets to be transmitted by using the received information.

Successively, the packet sending unit 222 receives the RTP data packets from the RTP data packet creation unit 212, and receives the redundant packets from the transmission FEC packet creation unit 221. The packet sending unit 222 transmits the RTP data packets and the redundant packets to a data reception device 250B (step S409).

(Reception Side)

A data reception device will be described.

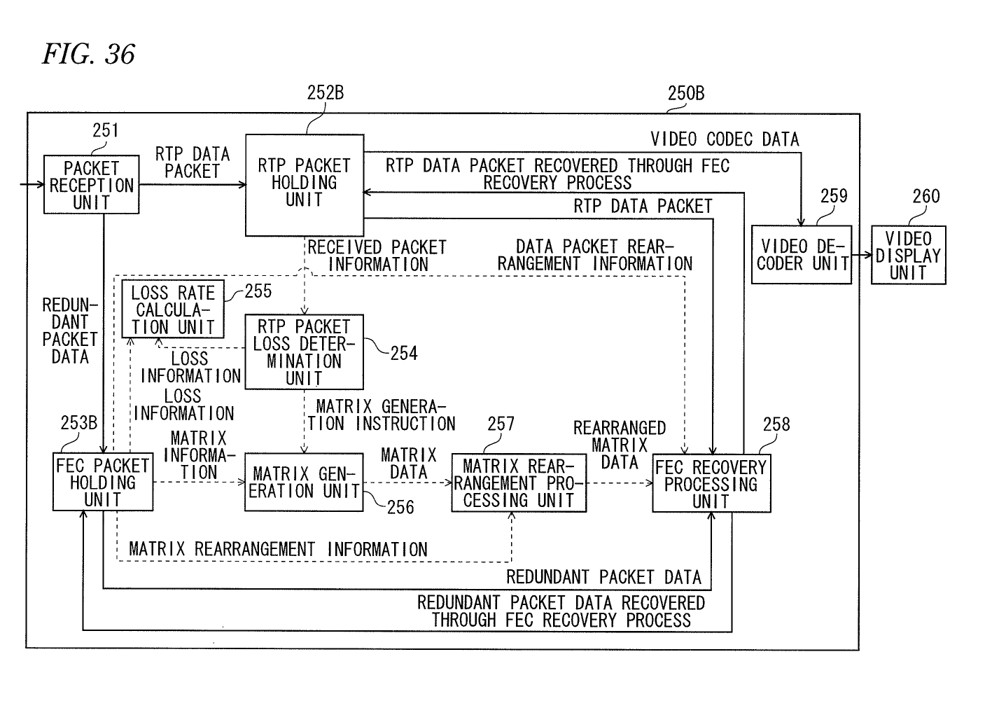

FIG. 36 is a block diagram illustrating a configuration example of the data reception device 250B according to the fourth embodiment of the present disclosure. In FIG. 25, a constituent element having the substantially same function as in the data reception device 150 of the first embodiment is given and indicated by the same reference number.

As illustrated in FIG. 36, a configuration of the data reception device 250B is substantially the same as the configuration of the data reception device 250 of FIG. 30. However, a function of an RTP packet holding unit 252B and a function of the FEC packet holding unit 253B are slightly changed.

The RTP packet holding unit 252B receives an RTP data packet from the packet reception unit 251. The RTP packet holding unit 252B obtains video codec data from the RTP data packet, and delivers the data to the video decoder unit 259.

In addition, the RTP packet holding unit 252B delivers the RTP data packet to the FEC recovery processing unit 258. In relation to this delivery, pointer information indicating a position where the data is preserved may be delivered.

Further, the RTP packet holding unit 252B delivers received packet information including information indicating reception circumstances, that is, whether or not a packet is lost, to the RTP packet loss determination unit 254. Furthermore, the RTP packet holding unit 252B receives a recovered RTP data packet from the FEC recovery processing unit 258.

The FEC packet holding unit 253B receives data of redundant packets from the packet reception unit 251. In addition, the FEC packet holding unit 253B notifies the FEC recovery processing unit 258 of the data of redundant packets. In relation to this notification, a notification of pointer information indicating a position which the data of redundant packets is preserved may be sent.

In addition, the FEC packet holding unit 253B delivers matrix information for generating a matrix added to the FEC header to the matrix generation unit 256. Further, the FEC packet holding unit 253B delivers the loss information of a redundant packet to the loss rate calculation unit 255. Since the number of redundant packets to be received can be found from the total number N of packets and the number k of data packets, the number of redundant packets which are not received can be known.

In addition, the FEC packet holding unit 253B receives a redundant packet which is recovered by the FEC recovery processing unit 258. The recovered redundant packet is held, and thus it is possible to recursively perform a recovery process.

In addition, the FEC packet holding unit 253B delivers the data packet rearrangement information added to the FEC header to the FEC recovery processing unit 258. Further, the FEC packet holding unit 253B notifies the matrix rearrangement processing unit 257 of the matrix rearrangement information.

Next, a flow of processes in the data reception device 250B will be described.

The flow of processes in the data reception device 250B is the same as the flow of processes illustrated in FIG. 33 described above, and thus description thereof will be omitted.

This disclosure is not limited to the constructions of the above embodiments, and applicable to any constructions which can achieve functions described in the claims or functions realized by constructions disclosed in the embodiments.

In the embodiments, the cases in which the invention is realized by hardware have been described. However, the invention may be realized by software which cooperates with a hardware.

Further, respective function blocks used in the description of the embodiments may be typically realized by an LSI that is an integrated circuit. They may be individually fabricated into one chip or a part or the whole of them may be fabricated into one chip. Here, although LSI is exemplified, it may be called an IC, a system LSI, a super LSI, an ultra LSI, or the like, depending on the difference in integrity.

Further, the technique for the integrated circuit is not limited to LSI, and may be realized as a dedicated circuit or a general purpose processor. After the LSI fabrication, a FPGA (Field Programmable Gate array) that can be programmed after fabrication of the LSI or a reconfigurable processor that can reconfigure the connection or setting of the circuit cells in the LSI may be used.

When a circuit integration technique capable of replacing LSI appears with the progress of semiconductor technology or other technologies derived from the semiconductor technology, the technique may be used to integrate the functional blocks. For example, biotechnology can be applied.

While the present invention has been described in detail, or with reference to the specific embodiments, it is apparent for those skilled in the art that the invention may be modified and changed in various manners without departing from the scope and spirit of the invention.

The present application is based on Japanese Patent Application No. 2012-019160 filed on Jan. 31, 2012, the entire content of which is incorporated by reference herein.

<Outline of One Aspect of the Disclosure>

A first communication device according to the disclosure comprises:

a data packet generation unit configured to generate data packets;

a data rearrangement processing unit configured to rearrange the data packets; and

a redundant packet generation unit configured to generate redundant packets for the data packets on the basis of data packets rearranged by the data rearrangement processing unit and matrix data applied to the data packets.

According to this configuration, it is possible to reduce a data amount of redundant packets by using rearranged data packets and matrix. Therefore, a data calculation amount is reduced when a redundant packet is created, and thus it is possible to reduce a processing load on the communication device. Further, a data amount sent to the communication path, and thus it is possible to efficiently use a band of the communication path.

A second communication device according to the first communication device further comprises:

a matrix data generation unit configured to generate the matrix data.

In a third communication device according to the first and second communication device,

the data rearrangement processing unit rearranges the data packets on the basis of a sum total of packet sizes of the redundant packets.

In a fourth communication device according to the third communication device,

the data rearrangement processing unit rearranges the data packets so that a sum total of packet sizes of the redundant packets is reduced.

In a fifth communication device according to any one of the first to the fourth communication device,

when packets are assigned to respective columns of the matrix data, the data rearrangement processing unit rearranges the data packets so that, as a row of the matrix data is located at a further upper position, a packet length of a data packet to be assigned is reduced.

A sixth communication device according to any one of the first to fifth communication device, further comprises:

a matrix rearrangement processing unit configured to rearrange rows of the matrix data,

wherein the redundant packet generation unit generates the redundant packets on the basis of data packets rearranged by the data rearrangement processing unit and matrix data rearranged by the matrix rearrangement processing unit.

In a seventh communication device according to the sixth communication device,

the matrix rearrangement processing unit rearranges rows of the matrix data before the data rearrangement processing unit rearranges the data packets.

In a eighth communication device according to the sixth or seventh communication device,

when data packets are assigned to respective columns of the matrix data, the matrix rearrangement processing unit rearranges rows of the matrix data so that, as a row of the matrix data is located at a further upper position, the number of data packets to be assigned is reduced.

A ninth communication device according to any one of the first to the eighth communication device, further comprises:

a data packet header generation unit configured to generate a data packet header which is a header of the data packet,

wherein the data packet header includes rearrangement information of data packets rearranged by the data rearrangement processing unit.

A tenth communication device according to any one of the first to eights communication device, further comprises:

a redundant packet header generation unit configured to generate a redundant packet header which is a header of the redundant packet,

wherein the redundant packet header includes rearrangement information of data packets rearranged by the data rearrangement processing unit.

A eleventh communication device according to the ninth or tenth communication device, further comprises:

a redundant packet header generation unit configured to generate a redundant packet header which is a header of the redundant packet,

wherein the redundant packet header includes rearrangement information of matrix data rearranged by the matrix rearrangement processing unit.

A twelfth communication device according to the ninth or tenth communication device, further comprises:

a redundant packet header generation unit configured to generate a redundant packet header which is a header of the redundant packet,

wherein the redundant packet header includes packet length information for recovering a packet length of a lost or incorrect packet which is not correctly received.

A thirteenth communication device according to the disclosure comprises:

a reception unit configured to receive reception packets which are packets including at least one of data packets and redundant packets for the data packets;

a data rearrangement processing unit configured to rearrange the data packets on the basis of data packet rearrangement information included in the reception packets; and

a recovery processing unit configured to recover an incorrect packet which is lost or is not correctly received by the reception unit on the basis of at least one of data packets rearranged by the data rearrangement processing unit and the redundant packets received by the reception unit, and matrix data applied to the data packets.

According to this configuration, it is possible to reliably recover a data packet by using at least one of a data packet and a redundant packet with a reduced data amount. In addition, since a data amount of redundant packets is reduced, a data calculation amount is reduced when a redundant packet is created, and thus it is possible to reduce a processing load on the communication device.

A fourteenth communication device according to the thirteenth communication device, further comprises:

a matrix rearrangement processing unit configured to rearrange rows of the matrix data on the basis of rearrangement information of the matrix data included in the reception packets,

wherein the recovery processing unit recovers an incorrect packet which is lost or is not correctly received by the reception unit on the basis of at least one of data packets rearranged by the data rearrangement processing unit and the redundant packets received by the reception unit, and matrix data rearranged by the matrix rearrangement processing unit.

In a fifteenth communication device according to the fourteenth communication device,

the matrix rearrangement processing unit rearranges rows of the matrix data before the data rearrangement processing unit rearranges the data packets.

A fifteenth communication method according to the disclosure comprises:

a step of generating data packets;

a step of rearranging the data packets; and

a step of generating redundant packets for the data packets on the basis of the rearranged data packets and matrix data applied to the data packets.

According to this method, it is possible to reduce a data amount of redundant packets by using rearranged data packets and matrix. Therefore, a data calculation amount is reduced when a redundant packet is created, and thus it is possible to reduce a processing load on the communication device. Further, a data amount sent to the communication path, and thus it is possible to efficiently use a band of the communication path.

A seventeenth communication method according to the disclosure comprises:

a step of receiving reception packets which are packets including at least one of data packets and redundant packets for the data packets;

a step of rearranging the data packets on the basis of data packet rearrangement information included in the reception packets; and

a step of recovering an incorrect packet which is lost or is not correctly received by the reception unit on the basis of at least one of the rearranged data packets and the received redundant packets, and matrix data applied to the data packets.

According to this method, it is possible to reliably recover a data packet by using at least one of a data packet and a redundant packet with a reduced data amount. In addition, since a data amount of redundant packets is reduced, a data calculation amount is reduced when a redundant packet is created, and thus it is possible to reduce a processing load on the communication device.

### INDUSTRIAL APPLICABILITY

The present disclosure is useful for a communication device or the like capable of reducing a data amount of redundant packets.

### REFERENCE SIGNS LIST

100, 1008, 200, and 200B Data transmission device
111 Video encoder unit
112 RTP data packet creation unit
113 Communication path loss rate calculation unit
114 Matrix generation unit
115 Data packet rearrangement processing unit
116 RTP header correction unit
117 Transmission RTP packet creation unit
118 FEC data creation unit
119 and 119B FEC header creation unit
120 Transmission FEC packet creation unit
121 Packet sending unit
150, 150B, 250, and 250B Data reception device
151 Packet reception unit
152 and 152B RTP packet holding unit
153 and 153B FEC packet holding unit
154 RTP packet loss determination unit
155 Loss rate calculation unit
156 Matrix generation unit
157 FEC recovery processing unit
158 Video decoder unit
159 Video display unit
211 Video encoder unit
212 RTP data packet creation unit
213 Communication path loss rate calculation unit
214 Matrix generation unit
215 Matrix rearrangement processing unit
216 Data packet rearrangement processing unit
217 RTP header correction unit
218 Transmission RTP packet creation unit
219 FEC header creation unit
220 and 220B FEC header creation unit
221 Transmission FEC packet creation unit
222 Packet sending unit
251 Packet reception unit
252 and 252B RTP packet holding unit
253 and 253B FEC packet holding unit
254 RTP packet loss determination unit
255 Loss rate calculation unit
256 Matrix generation unit
257 Matrix rearrangement processing unit
258 FEC recovery processing unit
259 Video decoder unit
260 Video display unit
PS10, PS11, and PS12 Data packet group
F1 Flag

1-17. (canceled)

18. A communication device comprising:
a data packet generation unit configured to generate data packets;
a data rearrangement processing unit configured to rearrange the data packets; and
a redundant packet generation unit configured to generate redundant packets for the data packets on the basis of data packets rearranged by the data rearrangement processing unit and matrix data applied to the data packets,
wherein the data rearrangement processing unit rearranges the data packets on the basis of a sum total of packet sizes of the redundant packets.

19. The communication device according to claim 18,
wherein the data rearrangement processing unit rearranges the data packets so that a sum total of packet sizes of the redundant packets is reduced.

20. The communication device according to claim 18,
wherein, when packets are assigned to respective columns of the matrix data, the data rearrangement processing unit rearranges the data packets so that, as a row of the matrix data is located at a further upper position, a packet length of a data packet to be assigned is reduced.

21. The communication device according to claim 18, further comprising:
a matrix rearrangement processing unit configured to rearrange rows of the matrix data,
wherein the redundant packet generation unit generates the redundant packets on the basis of data packets rearranged by the data rearrangement processing unit and matrix data rearranged by the matrix rearrangement processing unit.

22. The communication device according to claim 21,
wherein the matrix rearrangement processing unit rearranges rows of the matrix data before the data rearrangement processing unit rearranges the data packets.

23. The communication device according to claim 21,
wherein, when data packets are assigned to respective columns of the matrix data, the matrix rearrangement processing unit rearranges rows of the matrix data so that, as a row of the matrix data is located at a further upper position, the number of data packets to be assigned is reduced.

24. The communication device according to claim 18, further comprising:
a data packet header generation unit configured to generate a data packet header which is a header of the data packet,
wherein the data packet header includes rearrangement information of data packets rearranged by the data rearrangement processing unit.

25. The communication device according to claim 18, further comprising:
a redundant packet header generation unit configured to generate a redundant packet header which is a header of the redundant packet,
wherein the redundant packet header includes rearrangement information of data packets rearranged by the data rearrangement processing unit.

26. The communication device according to claim 24, further comprising:
a redundant packet header generation unit configured to generate a redundant packet header which is a header of the redundant packet,
wherein the redundant packet header includes rearrangement information of matrix data rearranged by the matrix rearrangement processing unit.

27. The communication device according to claim 24, further comprising:
a redundant packet header generation unit configured to generate a redundant packet header which is a header of the redundant packet,
wherein the redundant packet header includes packet length information for recovering a packet length of a lost or incorrect packet which is not correctly received.

28. A communication device comprising:
a reception unit configured to receive reception packets which are packets including at least one of data packets and redundant packets for the data packets;
a data rearrangement processing unit configured to rearrange the data packets on the basis of data packet rearrangement information included in the reception packets;
a recovery processing unit configured to recover an incorrect packet which is lost or is not correctly received by the reception unit on the basis of at least one of data packets rearranged by the data rearrangement processing unit and the redundant packets received by the reception unit, and matrix data applied to the data packets; and
a matrix rearrangement processing unit configured to rearrange rows of the matrix data on the basis of rearrangement information of the matrix data included in the reception packets,
wherein the recovery processing unit recovers an incorrect packet which is lost or is not correctly received by the reception unit on the basis of at least one of data packets rearranged by the data rearrangement processing unit and the redundant packets received by the reception unit, and matrix data rearranged by the matrix rearrangement processing unit.

29. The communication device according to claim 28,
wherein the matrix rearrangement processing unit rearranges rows of the matrix data before the data rearrangement processing unit rearranges the data packets.

30. A communication method comprising:
a step of generating data packets;
a step of rearranging the data packets; and
a step of generating redundant packets for the data packets on the basis of the rearranged data packets and matrix data applied to the data packets, wherein
the step of rearranging the data packets rearranges the data packets on the basis of a sum total of packet sizes of the redundant packets.

31. A communication method comprising:
a step of receiving reception packets which are packets including at least one of data packets and redundant packets for the data packets;
a step of rearranging the data packets on the basis of data packet rearrangement information included in the reception packets;
a step of recovering an incorrect packet which is lost or is not correctly received by the reception unit on the basis of at least one of the rearranged data packets and the received redundant packets, and matrix data applied to the data packets; and
a step of rearranging rows of the matrix data on the basis of rearrangement information of the matrix data included in the reception packets,
wherein the step of recovering recovers an incorrect packet which is lost or is not correctly received on the basis of at least one of rearranged data packets and the received redundant packets, and rearranged matrix data.

32. The communication device according to claim 25, further comprising:
a redundant packet header generation unit configured to generate a redundant packet header which is a header of the redundant packet,
wherein the redundant packet header includes rearrangement information of matrix data rearranged by the matrix rearrangement processing unit.

33. The communication device according to claim 25, further comprising:
a redundant packet header generation unit configured to generate a redundant packet header which is a header of the redundant packet,
wherein the redundant packet header includes packet length information for recovering a packet length of a lost or incorrect packet which is not correctly received.
